(19) United States
(12) Patent Application Publication
(10) Pub. No.: US 2025/0184947 A1
(43) Pub. Date: Jun. 5, 2025

(54) PRS MEASUREMENT PERIOD WITH MULTIPLE TEGS

(71) Applicant: QUALCOMM Incorporated, San Diego, CA (US)

(72) Inventors: Carlos CABRERA MERCADER, Cardiff, CA (US); Alexandros MANOLAKOS, Athens (GR); Sony AKKARAKARAN, Poway, CA (US); Sven FISCHER, Nuremberg (DE)

(21) Appl. No.: 18/842,755

(22) PCT Filed: May 5, 2023
(86) PCT No.: PCT/US2023/021240

§ 371 Date: Aug. 29, 2024

(30) Foreign Application Priority Data
May 6, 2022 (GR) 20220100374

(51) Int. Cl. H04W 64/00; H04L 5/00; H04W 8/22; H04W 24/10

(52) U.S. Cl. CPC H04W 64/00; H04L 5/0051; H04W 8/22; H04W 24/10

(57) ABSTRACT

Aspects presented herein relate to methods and devices for wireless communication including an apparatus, e.g., a UE or network entity. The apparatus may obtain an indication to measure a set of positioning reference signal (PRS) resources, wherein each of the set of PRS resources is associated with a plurality of timing error groups (TEGs). Additionally, the apparatus may perform, based on the indication, at least one measurement for each of the set of PRS resources, the at least one measurement being performed within a measurement period, wherein the at least one measurement corresponds to at least one TEG in the plurality of TEGs for each of the set of PRS resources. The apparatus may also transmit a report of the at least one measurement for each of the set of PRS resources to a network entity.

### CROSS REFERENCE TO RELATED APPLICATION(S)

This application claims the benefit of and priority to Greek Patent Application No. 20220100374, entitled “PRS MEASUREMENT PERIOD WITH MULTIPLE TEGS” and filed on May 6, 2022, which is expressly incorporated by reference herein in its entirety.

### TECHNICAL FIELD

The present disclosure relates generally to communication systems, and more particularly, to positioning measurements in wireless communication systems.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be an apparatus for wireless communication at a user equipment (UE). The apparatus may transmit a capability indication to the network entity, where the capability indication indicates at least one of a processing capability of the UE to perform at least one measurement for a set of positioning reference signal (PRS) resources or a buffering capability of the UE to store data associated with the at least one measurement for the set of PRS resources, where the indication is obtained based on the capability indication. The apparatus may also receive PRS assistance data based on the capability indication, where the set of PRS resources is based on the PRS assistance data. Further, the apparatus may obtain an indication to measure a set of positioning reference signal (PRS) resources, where each of the set of PRS resources is associated with a plurality of timing error groups (TEGs). The apparatus may also perform, based on the indication, at least one measurement for each of the set of PRS resources, the at least one measurement being performed within a measurement period, where the at least one measurement corresponds to at least one TEG in the plurality of TEGs for each of the set of PRS resources. The apparatus may also allocate an amount of a first memory or a first buffer for data associated with the at least one measurement for each of the set of PRS resources. Moreover, the apparatus may store the data associated with the at least one measurement for each of the set of PRS resources in the allocated amount of the first memory or the first buffer. The apparatus may also transmit a report of the at least one measurement for each of the set of PRS resources to a network entity.

In an aspect of the disclosure, a method, a computer-readable medium, and an apparatus are provided. The apparatus may be an apparatus for wireless communication at a network entity. The apparatus may receive a capability indication from a UE, where the capability indication indicates at least one of a processing capability of the UE to perform at least one measurement for a set of positioning reference signal (PRS) resources or a buffering capability of the UE to store data associated with the at least one measurement for the set of PRS resources, where the indication is transmitted based on the capability indication. The apparatus may also transmit PRS assistance data based on the capability indication, where the set of PRS resources is based on the PRS assistance data. Additionally, the apparatus may transmit an indication to measure a set of positioning reference signal (PRS) resources, where a plurality of measurements for each of the set of PRS resources is associated with a plurality of timing error groups (TEGs). The apparatus may also receive a report of at least one measurement for each of the set of PRS resources from a user equipment (UE), the at least one measurement being performed within a measurement period, where the at least one measurement corresponds to at least one TEG in the plurality of TEGs for each of the set of PRS resources.

To the accomplishment of the foregoing and related ends, the one or more aspects comprise the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating an example of a UE positioning based on reference signal measurements.

FIG. 5 is a diagram illustrating an example of a wireless communication system.

FIG. 6 is a diagram illustrating an example positioning procedure.

FIG. 7 is a diagram illustrating an example of a wireless communication system.

FIG. 8 is a diagram illustrating examples of positioning reference signal (PRS) durations and corresponding buffer amounts.

FIG. 9 is a diagram illustrating examples of an amount of PRS resources per slot and corresponding processing capabilities.

FIG. 10 is a communication flow diagram illustrating example communications between user equipment (UE) and a network entity.

FIG. 11 is a flowchart of a method of wireless communication.

FIG. 12 is a flowchart of a method of wireless communication.

FIG. 13 is a flowchart of a method of wireless communication.

FIG. 14 is a flowchart of a method of wireless communication.

FIG. 15 is a diagram illustrating an example of a hardware implementation for an example apparatus and/or network entity.

FIG. 16 is a diagram illustrating an example of a hardware implementation for an example network entity.

FIG. 17 is a diagram illustrating an example of a hardware implementation for an example network entity.

### DETAILED DESCRIPTION

Aspects of wireless communication may utilize different types of timing schemes or timing delays in order to provide more accurate positioning information or location information. For example, from a signal transmission perspective, there may be a delay from a time when a signal (e.g., a radio frequency (RF) signal) is generated at a baseband to the time when the signal is transmitted from a transmission (Tx) antenna of a device. Also, from a signal reception perspective, there may be a time delay from the time when the signal (e.g., an RF signal) arrives at a reception (Rx) antenna to the time when the signal is digitized and time-stamped at a baseband. In order to support positioning, a wireless device (e.g., a UE, a base station, or a transmission-reception point (TRP)) may implement an internal calibration or compensation of a Tx timing delay for the transmission of DL PRS or UL sounding reference signal (SRS) signals. Also, a UE or TRP may implement an internal calibration/compensation of an Rx timing delay before it reports the measurements that are obtained from the DL PRS or UL SRS signals. This delay or compensation may also include a calibration/compensation of a relative timing delay between different radio frequency (RF) chains in a same device (e.g., UE, base station, TRP). Moreover, the compensation may also consider an offset of an antenna phase center (e.g., an Rx antenna phase center or a Tx antenna phase center) to a physical antenna center. In some instances, a remaining Tx timing delay after a calibration (i.e., an un-calibrated Tx timing delay) may be defined as a Tx timing error. Similarly, a remaining Rx time delay after a calibration (i.e., an un-calibrated Rx time delay) may be defined as an Rx timing error. In some aspects, in order to compensate for the aforementioned timing delays, a wireless device may utilize a timing error group (TEG) for different positioning measurements. A TEG may be a group of measurements (or set of measurements) that are associated with a certain timing error. For instance, a TEG may be associated with a group of positioning measurements, where a timing error for a pair of measurements in the group of measurements may be within a margin of error. In some aspects, even when a UE indicates the ability to perform measurements with multiple Rx TEGs simultaneously, it may not mean that the UE's PRS processing capabilities are scaled by the number of Rx TEGs. As such, the UE may still be limited by the duration of PRS that it can buffer and the maximum number of PRS resources that it can process per slot. For example, if a UE is requested to measure PRS resources that amount to a certain PRS duration with an amount of TEGs, then the UE may buffer an equivalent PRS duration. If the requested PRS duration is less than the UE's buffer size, then the UE may have the capability to buffer the PRS duration. However, if the requested PRS duration is greater than the UE's buffer size, then there may be an issue. As indicated herein, in some aspects, reporting multiple measurements associated with different Rx TEGs per PRS resource may necessitate additional Rx samples to be stored in memory at the UE and/or additional processing at the UE. Aspects of the present disclosure may allow UEs to report or specify a measurement period length for PRS resources associated with multiple timing error groups (TEGs). In some instances, aspects presented herein may allow the reporting of a measurement period length for a UE that can support simultaneous positioning measurements. That is, aspects of the present disclosure may report or specify the measurement period length for a UE that can support simultaneous measurements without exceeding the UE's PRS processing capabilities. Aspects presented herein may also allow UE's to report or specify a measurement period length that is with the processing capabilities of the UE. Additionally, aspects of the present disclosure may utilize a PRS measurement period (e.g., a delay period) for a UE that supports performing multiple measurements of a PRS resource simultaneously. For instance, each measurement for the UE may be associated with a different reception (Rx) TEG or reception-transmission (RxTx) TEG. Further, aspects presented herein may allow additional Rx samples to be stored in memory and additional processing at the UE when reporting multiple measurements associated with different Rx TEGs per PRS resource.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

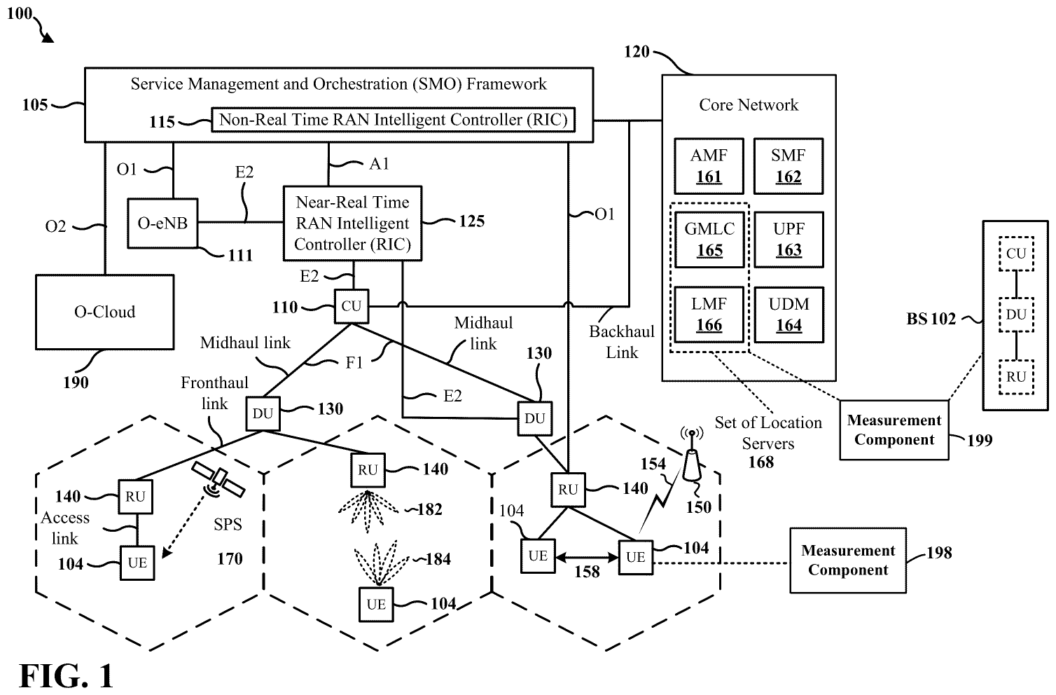

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUs 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit—User Plane (CU-UP)), control plane functionality (i.e., Central Unit—Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base stations 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth®, Wi-Fi® based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a transmit reception point (TRP), network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the serving base station 102. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may include a measurement component 198 that may be configured to transmit a capability indication to the network entity, where the capability indication indicates at least one of a processing capability of the UE to perform at least one measurement for a set of positioning reference signal (PRS) resources or a buffering capability of the UE to store data associated with the at least one measurement for the set of PRS resources, where the indication is obtained based on the capability indication. Measurement component 198 may also be configured to receive PRS assistance data based on the capability indication, where the set of PRS resources is based on the PRS assistance data. Measurement component 198 may also be configured to obtain an indication to measure a set of positioning reference signal (PRS) resources, where each of the set of PRS resources is associated with a plurality of timing error groups (TEGs). Measurement component 198 may also be configured to perform, based on the indication, at least one measurement for each of the set of PRS resources, the at least one measurement being performed within a measurement period, where the at least one measurement corresponds to at least one TEG in the plurality of TEGs for each of the set of PRS resources. Measurement component 198 may also be configured to allocate an amount of a first memory or a first buffer for data associated with the at least one measurement for each of the set of PRS resources. Measurement component 198 may also be configured to store the data associated with the at least one measurement for each of the set of PRS resources in the allocated amount of the first memory or the first buffer. Measurement component 198 may also be configured to transmit a report of the at least one measurement for each of the set of PRS resources to a network entity.

In certain aspects, the base station 102 and/or LMF 166 may include a measurement component 199 that may be configured to receive a capability indication from a UE, where the capability indication indicates at least one of a processing capability of the UE to perform at least one measurement for a set of positioning reference signal (PRS) resources or a buffering capability of the UE to store data associated with the at least one measurement for the set of PRS resources, where the indication is transmitted based on the capability indication. Measurement component 199 may also be configured to transmit PRS assistance data based on the capability indication, where the set of PRS resources is based on the PRS assistance data. Measurement component 199 may also be configured to transmit an indication to measure a set of positioning reference signal (PRS) resources, where a plurality of measurements for each of the set of PRS resources is associated with a plurality of timing error groups (TEGs). Measurement component 199 may also be configured to receive a report of at least one measurement for each of the set of PRS resources from a user equipment (UE), the at least one measurement being performed within a measurement period, where the at least one measurement corresponds to at least one TEG in the plurality of TEGs for each of the set of PRS resources. Although the following description may be focused on 5G NR, the concepts described herein may be applicable to other similar areas, such as LTE, LTE-A, CDMA, GSM, and other wireless technologies.

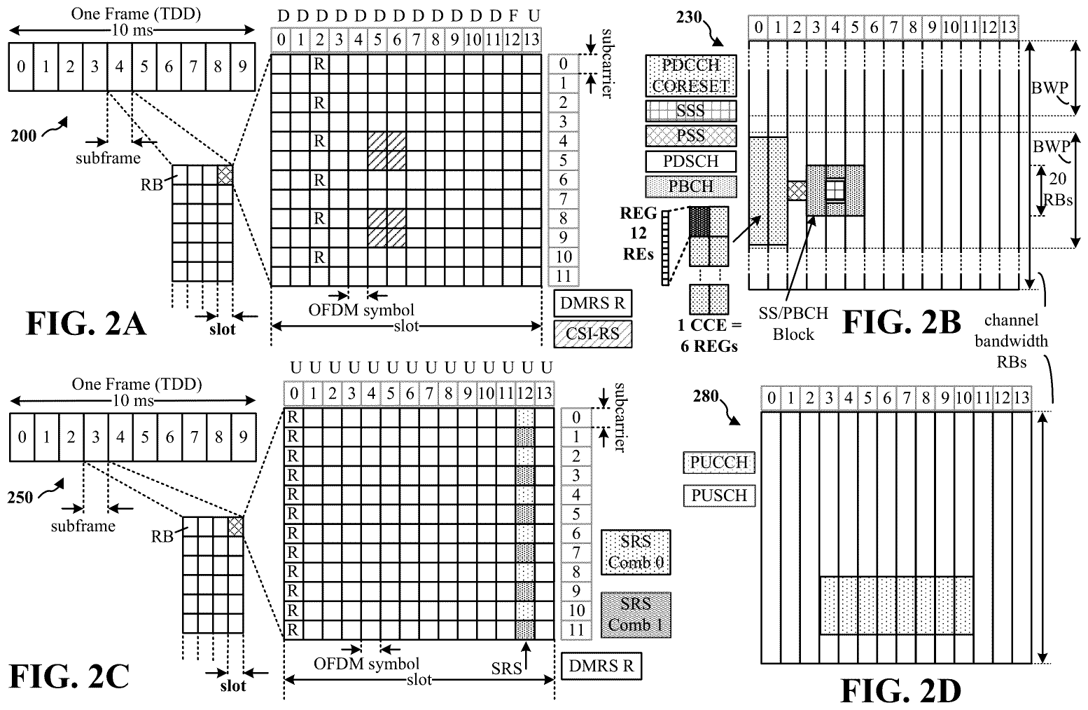

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the CP and the numerology. The numerology defines the subcarrier spacing (SCS) and, effectively, the symbol length/duration, which is equal to 1/SCS.

| | SCS | Cyclic |
|---|---|---|
| μ | Δf = 2^{μ} · 15 [KHz] | prefix |
| 0 | 15 | Normal |
| 1 | 30 | Normal |
| 2 | 60 | Normal, Extended |
| 3 | 120 | Normal |
| 4 | 240 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

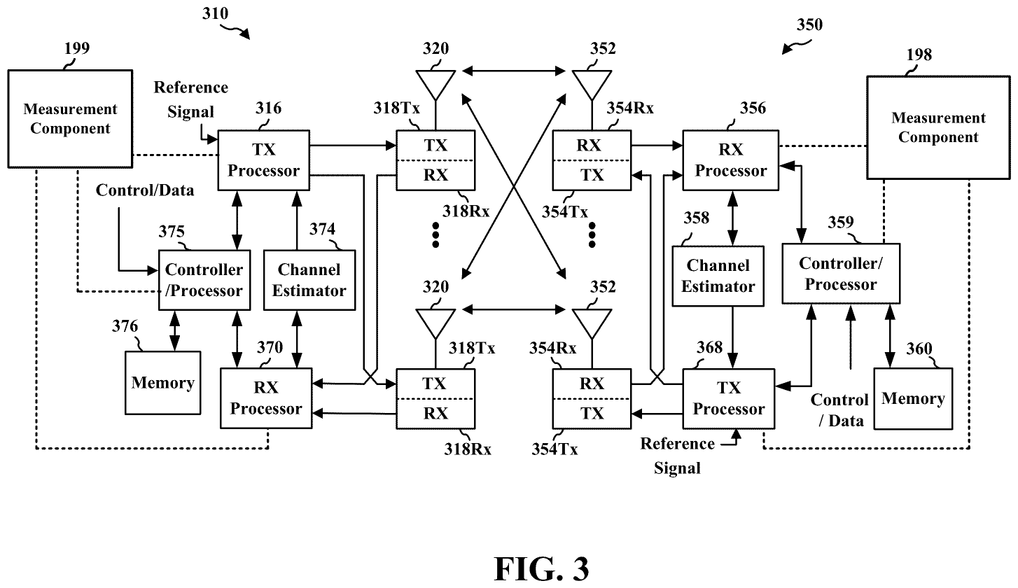

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the measurement component 198 of FIG. 1. At least one of the TX processor 316, the RX processor 370, and the controller/processor 375 may be configured to perform aspects in connection with the measurement component 199 of FIG. 1.

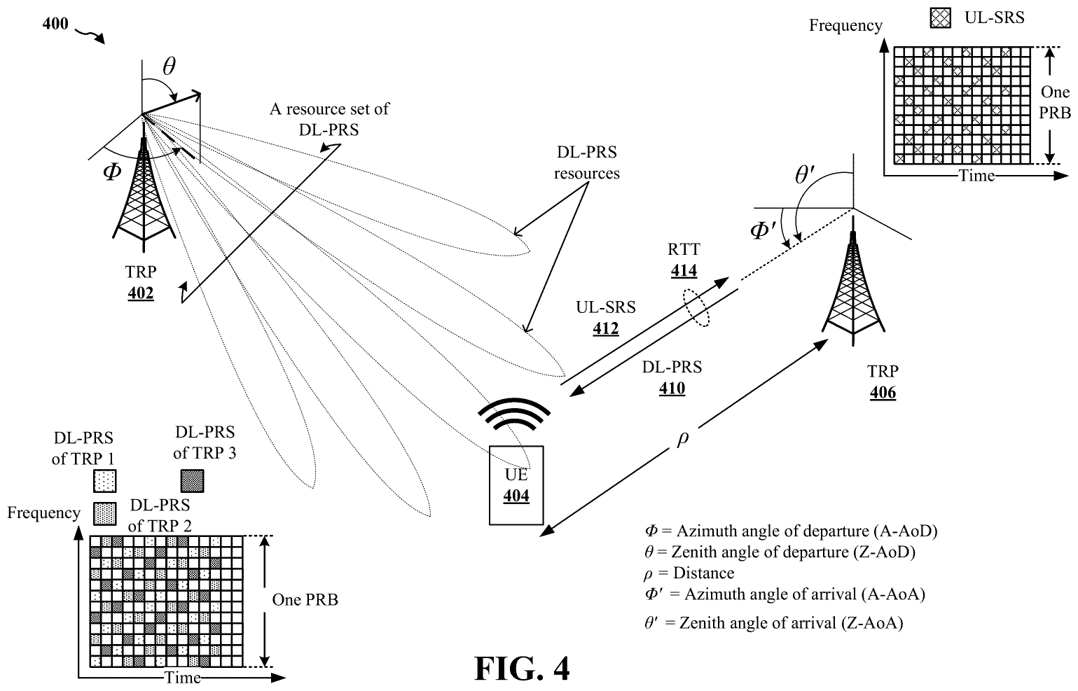

FIG. 4 is a diagram 400 illustrating an example of a UE positioning based on reference signal measurements. The UE 404 may transmit UL-SRS 412 at time T_{SRS_TX} and receive DL positioning reference signals (PRS) (DL-PRS) 410 at time T_{PRS_RX}. The TRP 406 may receive the UL-SRS 412 at time T_{SRS_RX} and transmit the DL-PRS 410 at time T_{PRS_TX}. The UE 404 may receive the DL-PRS 410 before transmitting the UL-SRS 412, or may transmit the UL-SRS 412 before receiving the DL-PRS 410. In both cases, a positioning server (e.g., location server(s)168) or the UE 404 may determine the RTT 414 based on ∥T_{SRS_RX}−T_{PRS_TX}|−|T_{SRS_TX}−T_{PRS_RX}∥. Accordingly, multi-RTT positioning may make use of the UE Rx-Tx time difference measurements (i.e., |T_{SRS_TX}−T_{PRS_RX}|) and DL-PRS reference signal received power (RSRP) (DL-PRS-RSRP) of downlink signals received from multiple TRPs 402, 406 and measured by the UE 404, and the measured TRP Rx-Tx time difference measurements (i.e., |T_{SRS_RX}−T_{PRS_TX}|) and UL-SRS-RSRP at multiple TRPs 402, 406 of uplink signals transmitted from UE 404. The UE 404 measures the UE Rx-Tx time difference measurements (and optionally DL-PRS-RSRP of the received signals) using assistance data received from the positioning server, and the TRPs 402, 406 measure the gNB Rx-Tx time difference measurements (and optionally UL-SRS-RSRP of the received signals) using assistance data received from the positioning server. The measurements may be used at the positioning server or the UE 404 to determine the RTT, which is used to estimate the location of the UE 404. Other methods are possible for determining the UE location, such as for example using DL-TDOA and/or UL-TDOA measurements.

DL-AoD positioning may make use of the measured DL-PRS-RSRP of downlink signals received from multiple TRPs 402, 406 at the UE 404. The UE 404 measures the DL-PRS-RSRP of the received signals using assistance data received from the positioning server, and the resulting measurements are used along with the azimuth angle of departure (A-AoD), the zenith angle of departure (Z-AoD), and other configuration information to locate the UE 404 in relation to the neighboring TRPs 402, 406. DL-TDOA positioning may make use of the DL reference signal time difference (RSTD) (and optionally DL-PRS-RSRP) of downlink signals received from multiple TRPs 402, 406 at the UE 404. The UE 404 measures the DL RSTD (and optionally DL-PRS-RSRP) of the received signals using assistance data received from the positioning server, and the resulting measurements are used along with other configuration information to locate the UE 404 in relation to the neighboring TRPs 402, 406.

UL-TDOA positioning may make use of the UL relative time of arrival (RTOA) (and optionally UL-SRS-RSRP) at multiple TRPs 402, 406 of uplink signals transmitted from UE 404. The TRPs 402, 406 measure the UL-RTOA (and optionally UL-SRS-RSRP) of the received signals using assistance data received from the positioning server, and the resulting measurements are used along with other configuration information to estimate the location of the UE 404. UL-AoA positioning may make use of the measured azimuth angle of arrival (A-AoA) and zenith angle of arrival (Z-AoA) at multiple TRPs 402, 406 of uplink signals transmitted from the UE 404. The TRPs 402, 406 measure the A-AoA and the Z-AoA of the received signals using assistance data received from the positioning server, and the resulting measurements are used along with other configuration information to estimate the location of the UE 404.

Additional positioning methods may be used for estimating the location of the UE 404, such as for example, UE-side UL-AoD and/or DL-AoA. Note that data/measurements from various technologies may be combined in various ways to increase accuracy, to determine and/or to enhance certainty, to supplement/complement measurements, and/or to substitute/provide for missing information.

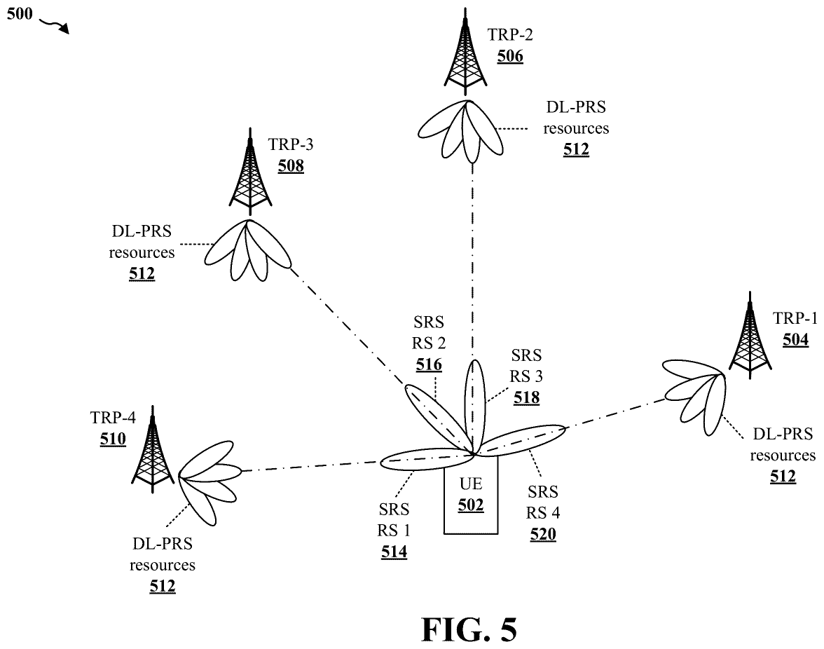

FIG. 5 is a diagram 500 illustrating an example of estimating a position of a UE based on multi-RTT measurements from multiple TRPs in accordance with various aspects of the present disclosure. A UE 502 may be configured by a serving base station to decode DL-PRS resources 512 that correspond to and are transmitted from a first TRP 504 (TRP-1), a second TRP 506 (TRP-2), a third TRP 508 (TRP-3), and a fourth TRP 510 (TRP-4). The UE 502 may also be configured to transmit UL-SRSs on a set of UL-SRS resources, which may include a first SRS resource 514, a second SRS resource 516, a third SRS resource 518, and a fourth SRS resource 520, such that the serving cell(s), e.g., the first TRP 504, the second TRP 506, the third TRP 508, and the fourth TRP 510, and as well as other neighbor cell(s), may be able to measure the set of the UL-SRS resources transmitted from the UE 502. For multi-RTT measurements based on DL-PRS and UL-SRS, as there may be an association between a measurement of a UE for the DL-PRS and a measurement of a TRP for the UL-SRS, the smaller the gap is between the DL-PRS measurement of the UE and the UL-SRS transmission of the UE, the better the accuracy may be for estimating the position of the UE and/or the distance of the UE with respect to each TRP.

In some aspects of wireless communication, the terms “positioning reference signal” and “PRS” may generally refer to specific reference signals that are used for positioning in NR and LTE systems. However, as used herein, the terms “positioning reference signal” and “PRS” may also refer to any type of reference signal that can be used for positioning, such as but not limited to, PRS as defined in LTE and NR, TRS, PTRS, CRS, CSI-RS, DMRS, PSS, SSS, SSB, SRS, UL-PRS, etc. In addition, the terms “positioning reference signal” and “PRS” may refer to downlink or uplink positioning reference signals, unless otherwise indicated by the context. If needed to further distinguish the type of PRS, a downlink positioning reference signal may be referred to as a “DL-PRS,” and an uplink positioning reference signal (e.g., an SRS-for-positioning, PTRS) may be referred to as an “UL-PRS.” In addition, for signals that may be transmitted in both the uplink and downlink (e.g., DMRS, PTRS), the signals may be prepended with “UL” or “DL” to distinguish the direction. For example, “UL-DMRS” may be differentiated from “DL-DMRS.”

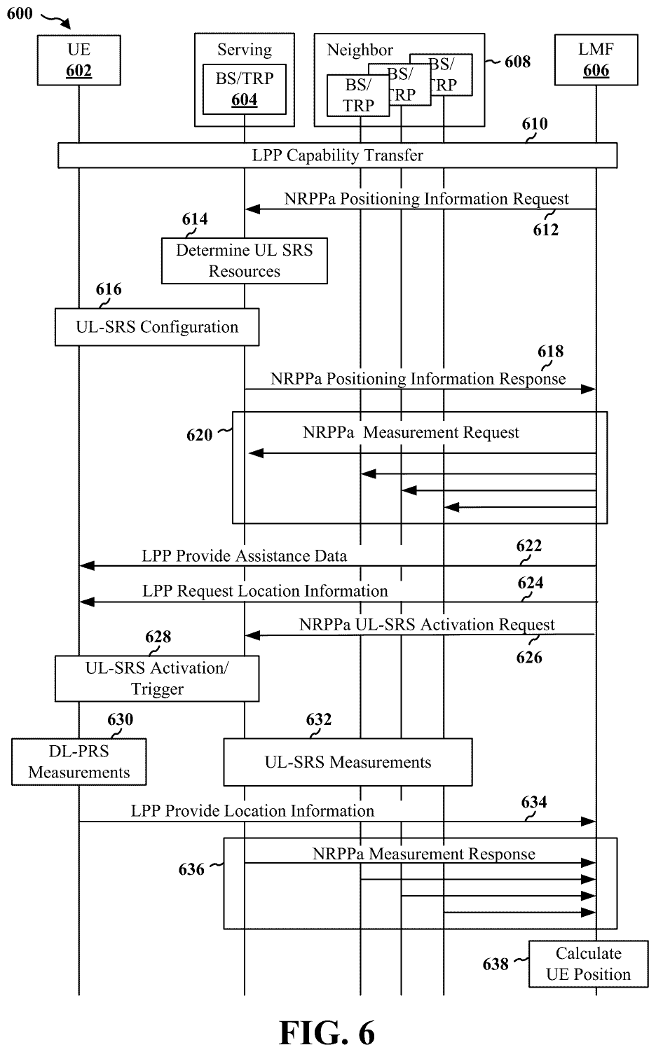

FIG. 6 is a communication flow 600 illustrating an example multi-RTT positioning procedure in accordance with various aspects of the present disclosure. The numberings associated with the communication flow 600 do not specify a particular temporal order and are merely used as references for the communication flow 600. In addition, a DL-only and/or an UL-only positioning may use a subset or subsets of this multi-RTT positioning procedure.

At 610, an LMF 606 may request one or more positioning capabilities from a UE 602 (e.g., from a target device). In some examples, the request for the one or more positioning capabilities from the UE 602 may be associated with an LTE Positioning Protocol (LPP). For example, the LMF 606 may request the positioning capabilities of the UE 602 using an LPP capability transfer procedure. At 612, the LMF 606 may request UL SRS configuration information for the UE 602. The LMF 606 may also provide assistance data specified by a serving base station 604 (e.g., pathloss reference, spatial relation, and/or SSB configuration(s), etc.). For example, the LMF 606 may send an NR Positioning Protocol A (NRPPa) positioning information request message to the serving base station 604 to request UL information for the UE 602.

At 614, the serving base station 604 may determine resources available for UL SRS, and at 616, the serving base station 604 may configure the UE 602 with one or more UL SRS resource sets based on the available resources. At 618, the serving base station 604 may provide UL SRS configuration information to the LMF 606, such as via an NRPPa positioning information response message. At 620, the LMF 606 may select one or more candidate neighbor BSs/TRPs 608, and the LMF 606 may provide an UL SRS configuration to the one or more candidate neighbor BSs/TRPs 608 and/or the serving base station 604, such as via an NRPPa measurement request message. The message may include information for enabling the one or more candidate neighbor BSs/TRPs 608 and/or the serving base station to perform the UL measurements.

At 622, the LMF 606 may send an LPP provide assistance data message to the UE 602. The message may include specified assistance data for the UE 602 to perform the DL measurements. At 624, the LMF 606 may send an LPP request location information message to the UE 602 to request multi-RTT measurements. At 626, for semi-persistent or aperiodic UL SRS, the LMF 606 may request the serving base station 604 to activate/trigger the UL SRS in the UE 602. For example, the LMF 606 may request activation of UE SRS transmission by sending an NRPPa positioning activation request message to the serving base station 604.

At 628, the serving base station 604 may activate the UE SRS transmission and send an NRPPa positioning activation response message. In response, the UE 602 may begin the UL-SRS transmission according to the time domain behavior of UL SRS resource configuration. At 630, the UE 602 may perform the DL measurements from the one or more candidate neighbor BSs/TRPs 608 and/or the serving base station 604 provided in the assistance data. At 632, each of the configured one or more candidate neighbor BSs/TRPs 608 and/or the serving base station 604 may perform the UL measurements. At 634, the UE 602 may report the DL measurements to the LMF 606, such as via an LPP provide location information message. At 636, each of the one or more candidate neighbor BSs/TRPs 608 and/or the serving base station 604 may report the UL measurements to the LMF 606, such as via an NRPPa measurement response message. At 638, the LMF 606 may determine the RTTs from the UE 602 and BS/TRP Rx-Tx time difference measurements for each of the one or more candidate neighbor BSs/TRPs 608 and/or the serving base station 604 for which corresponding UL and DL measurements were provided at 634 and 636, and the LMF 606 may calculate the position of the UE 602.

In some aspects of wireless communication, reference signals (e.g., positioning reference signals (PRSs) and sounding reference signals (SRSs)) and physical channels associated with UE positioning may be configured to be on-demand transmissions and receptions to improve network energy savings, resource utilization, and/or latency positioning latency. For example, a UE may be configured with a set of periodic PRS resources for a UE positioning session. However, periodic PRS scheduling may consume resources from data scheduling, thereby reducing available resources for data scheduling. On the other hand, if the UE positioning session is configured with on-demand transmission and/or reception, a UE may request the PRS to be transmitted based on the situation, which may reduce a number of PRSs transmitted from a transmission-reception point (TRP).

In some examples, an on-demand transmission and reception may also enable a UE to request a burst of PRS to be transmitted between broadcasted PRS, which may improve positioning latency for UE positioning. The on-demand configuration may also enable a UE to skip monitoring for PRS at all time, which may help conserve network resources and UE power. For purposes of the present disclosure, the term “on-demand” may refer to a configuration that is triggered based on a request or an event. For example, an on-demand downlink PRS (DL-PRS) transmission may refer to a configuration that enables a UE or a location management function (LMF) to request DL-PRS to be transmitted to the UE based on demands. In addition, such configuration may be initiated by the UE and/or the LMF. For example, on-demand transmission and reception of DL-PRS for downlink (DL) positioning and downlink plus uplink (DL+UL) positioning may be configured for UE-based positioning and UE-assisted positioning, which may include UE-initiated request of on-demand DL-PRS transmission and LMF (network)-initiated request of on-demand DL-PRS transmission, etc.

Aspects of wireless communication may utilize different types of timing schemes or timing delays in order to provide more accurate positioning information or location information. For example, from a signal transmission perspective, there may be a delay from a time when a signal (e.g., a radio frequency (RF) signal) is generated at a baseband to the time when the signal is transmitted from a transmission (Tx) antenna of a device. Also, from a signal reception perspective, there may be a time delay from the time when the signal (e.g., an RF signal) arrives at a reception (Rx) antenna to the time when the signal is digitized and time-stamped at a baseband. In order to support positioning, a wireless device (e.g., a UE, a base station, or a TRP) may implement an internal calibration or compensation of a Tx timing delay for the transmission of DL PRS or UL SRS signals. Also, a UE or TRP may implement an internal calibration/compensation of an Rx timing delay before it reports the measurements that are obtained from the DL PRS or UL SRS signals. This delay or compensation may also include a calibration/compensation of a relative timing delay between different radio frequency (RF) chains in a same device (e.g., UE, base station, TRP). Moreover, the compensation may also consider an offset of an antenna phase center (e.g., an Rx antenna phase center or a Tx antenna phase center) to a physical antenna center. In some instances, a remaining Tx timing delay after a calibration (i.e., an un-calibrated Tx timing delay) may be defined as a Tx timing error. Similarly, a remaining Rx time delay after a calibration (i.e., an un-calibrated Rx time delay) may be defined as an Rx timing error.

In some aspects, in order to compensate for the aforementioned timing delays, a wireless device may utilize a timing error group (TEG) for different positioning measurements. A TEG may be a group of measurements (or set of measurements) that are associated with a certain timing error. For instance, a TEG may be associated with a group of positioning measurements, where a timing error for a pair of measurements (or a relative timing error between a pair of measurements) in the group of measurements may be within a margin of error. A Tx TEG (e.g., a UE/TRP Tx TEG) may be associated with a transmission of one or more UL SRS resources or DL PRS resources for positioning purposes, which has Tx timing errors within a certain margin. Also, an Rx TEG (e.g., a UE/TRP Rx TEG) may be associated with one or more DL measurements or UL measurements, which have Rx timing errors within a certain margin. Further, an Rx-Tx TEG (e.g., a UE/TRP Rx-Tx TEG) may be associated with one or more Rx-Tx time difference measurements (e.g., UE Rx-Tx time difference measurements) and one or more UL SRS resources or DL PRS resources for positioning purposes, which have a sum of Rx timing errors plus Tx timing errors within a certain margin.

Some UEs may support certain types of TEGs, such as UE Rx TEGs for UE-assisted DL TDOA and/or multi-RTT positioning. In some instances, this may include a maximum number of UE Rx TEGs that are supported and reported by a UE for UE-assisted DL TDOA and/or multi-RTT positioning. Further, if UE Rx TEG reporting is not supported, then no assumption may be made on the UE Rx timing errors for the measurements. In some aspects, a location server may need to know if this feature is supported by the UE. For instance, a UE may transmit a measurement report (e.g., report a single value) when both multi-RTT and DL-TDOA are supported at the UE. If the UE does not include Rx TEG IDs associated with a measurement, the location server may not make any assumptions regarding the UE Rx timing errors for the measurement. Also, a “per-band” reporting for this capability may not imply that the Rx TEG IDs in the measurement report are grouped on a per-band basis. In the measurement report, the Rx TEG ID may include a number of different values (e.g., values from 0 to 31). Moreover, some UEs may support UE Rx TEGs for measuring the same DL PRS resource (e.g., measuring the same DL PRS resource simultaneously). In some instances, this may include the maximum number of different UE Rx TEGs that a UE can support to measure the same DL PRS of a TRP, or a maximum number of UE Rx TEGs for measuring the same DL PRS resource simultaneously. If this feature is not supported by a UE, up to 1 Rx TEG may be used to measure the same DL PRS resource of a TRP.

Additionally, UEs may support different types of processing capabilities, such as UE PRS processing capabilities. For example, an NR DL PRS processing capability (NR-DL-PRS-ProcessingCapability) may indicate common DL PRS processing capabilities applicable across all NR positioning methods supported by the UE. A UE PRS processing capability may also include a maximum number of positioning frequency layers supported by the UE. For each supported frequency band, there may be different parameters used to indicate different capabilities. A DL PRS buffer type parameter (dl-PRS-BufferType) may indicate a PRS buffering capability. For example, a dl-PRS-BufferType type 1 parameter may indicate a symbol-level buffering, while a dl-PRS-BufferType type 2 parameter may indicate a slot-level buffering. Moreover, a duration of PRS processing parameter (durationOfPRS-Processing) may indicate a duration N (in ms) of PRS that the UE can process every time T (in ms) assuming a maximum PRS bandwidth indicated in a supported bandwidth PRS parameter (supportedBandwidthPRS). For example, N may be equal to {0.125, 0.25, 0.5, 1, 2, 4, 6, 8, 12, 16, 20, 25, 30, 32, 35, 40, 45, 50}, while T may be equal to {8, 16, 20, 30, 40, 80, 160, 320, 640, 1280}. Further, a maxNumOfDL-PRS-ResProcessedPerSlot parameter may indicate a maximum number of PRS resources that the UE can process per slot for each subcarrier spacing (SCS) (e.g., SCS15, SCS30, SCS60 and SCS120). For example, N′ may be equal to {1, 2, 4, 8, 16, 24, 32, 48, 64}.

Additionally, aspects of wireless communication may utilize a measurement period for the certain positioning measurements (e.g., a reference signal time difference (RSTD) measurement). The measurement period may be a condition or specification for wireless devices (e.g., UEs) performing positioning measurements or location measurements. In some instances, the length of the measurement period may be represented by T_{RSTD,Total} for a certain number of positioning frequency layers (PFLs) (e.g., L PFLs). For example, in some aspects, T_{RSTD,Total}=Σᵢ₌₁^{L} T_{RSTD,i}+(L−1)*max(T_{effect,i}), where T_{RSTD,i} is the time length per PFL term, max(T_{effect,i}) is a maximum number of transitions between PFLs, and i is a PFL index. Also, in some aspects,

$${T}_{RSTD , i} = ( {CSSF}_{PRS , i} * {N}_{ExBeam , i} * ⌈ \frac{{N}_{PRS , i}^{slot}}{{N}_{i}^{′}} ⌉ ⌈ \frac{{L}_{available\_PRS , i}}{{N}_{i}} ⌉ * {N}_{sample} - 1 ) *$$

T_{effect,i}+T_{last,i}. In the above formula, CSSF_{PRS,i} is the carrier-specific scaling factor (CSSF) for PRS-based measurements, N_{RxBeam,i} is the UE Rx beam sweeping factor (e.g., N_{RxBeam,i}=1 for FR1 and N_{RxBeam,i}=8 for FR2), and N_{PRS,i}^{slot} is the maximum number of DL PRS resources per slot. Also, {Nᵢ, Tᵢ} and Nᵢ′ are UE capabilities corresponding to the parameters durationOfPRS-Processing and maxNumOfDL-PRS-ResProcessedPerSlot, respectively. L_{available_PRS,i} is the time duration of available PRS to be measured during T_{available_PRS,i}, Nₛₐₘₚₗₑ is the number of PRS RSTD samples (e.g., 4), and

$${T}_{effect , i} = ⌈ \frac{{T}_{i}}{{T}_{available\_PRS , i}} ⌉ * {T}_{available\_PRS , i} .$$

Further, Tₗₐₛₜ is a measurement duration for a last PRS sample. In one example, for measurements within measurement gaps in connected state, T_{last,i} is the measurement duration for the last PRS [RSTD/PRS-RSRP/UE Rx-Tx]sample in positioning frequency layer i, including the sampling time and processing time. If all of the PRS resources to be measured are available in the same measurement gap (MG) occasion during Tavailabe, T_{last,i}=Tᵢ+MG length (MGL). Otherwise, Tₗₐₛₜ=Tᵢ+T_{available_PRS,i}, where T_{available_PRS,i} is the least common multiple between T_{PRS,i} and MGRPᵢ, where MGRPᵢ is the measurement gap periodicity and T_{PRS,i} is the effective PRS periodicity with PRS muting. Moreover, T_{PRS,i} is the least common multiple between N_{muting,k} and T_{per,k}^{PRS}, where k is the resource set index, Tₚₑᵣ^{PRS} is the higher-layer parameter DL-PRS-Periodicity, and N_{muting} is a scaling factor considering PRS muting. In another example, for measurements without measurement gaps in connected state, T_{last,i} is the measurement duration for the last PRS [RSTD/PRS-RSRP/UE Rx-Tx]sample in positioning frequency layer i, including the sampling time and processing time. If positioning frequency layer i is in Case 1 and all of the PRS resources to be measured are available in the same PRS processing window (PPW) occasion during T_{available}, then T_{last,i}=Tᵢ+PPWL, else if positioning frequency layer i is in Case 2 and all of the PRS resources to be measured are available in the same PPW occasion during T_{available}, then T_{last,i}=PPW length (PPWL); otherwise, T_{last,i}=Tᵢ+T_{available_PRS,i}. In another example, for measurements in inactive state, T_{last,i} is the measurement duration for the last PRS [RSTD/PRS-RSRP/UE Rx-Tx]sample in positioning frequency layer i, including the sampling time and processing time, T_{last,i}=Tᵢ+T_{available_PRS,i}.

In aspects of wireless communication, there are a number different circumstances and conditions for the use of the aforementioned measurement period. For instance, TEGs (e.g., Rx TEGs, Tx TEGs, or RxTx TEGs) may have an impact on PRS measurement core conditions, such as the measurement period. In some instances, subject to UE capability, the measurement period may be extended if an LMF requests a UE to measure the same DL PRS resource of a TRP with N different UE Rx TEGs and report the corresponding multiple RSTD measurements. For UEs that support certain wireless capabilities, the existing measurement period may be scaled by N if the UE is requested to measure the same PRS resource with N different UE Rx TEGs. For UEs that support other wireless capabilities, the existing measurement period may be scaled (e.g., scaled by a value of N, k, or a combination of N and k) if the UE is requested to measure a same PRS resource with N different UE Rx TEGs, where k is the value reported by the UE.

In some aspects, even when a UE indicates the ability to perform measurements with multiple Rx TEGs simultaneously, it may not mean that the UE's PRS processing capabilities (e.g., capabilities N and N′) are scaled by the number of Rx TEGs. As such, the UE may still be limited by the duration of PRS that it can buffer and the maximum number of PRS resources that it can process per slot. For example, if a UE is requested to measure PRS resources that amount to a certain PRS duration with an amount of TEGs (e.g., a PRS duration of L_{available_PRS,i} with M Rx TEGs), then the UE may buffer an equivalent PRS duration (e.g., a PRS duration of M L_{available_PRS,i}), which may be compared against the UE's buffering capability N. If the requested PRS duration (e.g., a PRS duration of M·L_{available_PRS,i}) is less than the UE's buffer size, then the UE may have the capability to buffer the PRS duration. However, if the requested PRS duration (e.g., a PRS duration of M·L_{available_PRS,i}) is greater than the UE's buffer size, then there may be an issue. Additionally, if the UE is requested to process M different sets of samples of the same PRS resource (e.g., samples all in the same slot), then the UE may need to process an amount of PRS resources per slot (e.g., M·N_{PRS,i}^{slot} PRS resources per slot). This amount of processed PRS resources per slot for the UE may need to be compared against the UE's capability N′.

As indicated herein, in some aspects, reporting multiple measurements associated with different Rx TEGs per PRS resource may necessitate additional Rx samples to be stored in memory at the UE and/or additional processing at the UE. Based on the above, it may be beneficial for the UE to report or specify the measurement period length for PRS resources associated with multiple timing error groups (TEGs). Further, it may be beneficial to report or specify the measurement period length for a UE that can support simultaneous positioning measurements. That is, it may be beneficial to report or specify the measurement period length for a UE that can support simultaneous measurements without exceeding the UE's PRS processing capabilities (e.g., processing capabilities N and N′). As such, it may be beneficial for a UE to report or specify a measurement period length that is within the processing capabilities of the UE.

Aspects of the present disclosure may allow UEs to report or specify a measurement period length for PRS resources associated with multiple timing error groups (TEGs). In some instances, aspects presented herein may allow the reporting of a measurement period length for a UE that can support simultaneous positioning measurements. That is, aspects of the present disclosure may report or specify the measurement period length for a UE that can support simultaneous measurements without exceeding the UE's PRS processing capabilities (e.g., processing capabilities N and N′). Aspects presented herein may also allow UE's to report or specify a measurement period length that is with the processing capabilities of the UE. Additionally, aspects of the present disclosure may utilize a PRS measurement period (e.g., a delay period) for a UE that supports performing multiple measurements of a PRS resource simultaneously. For instance, each measurement for the UE may be associated with a different reception (Rx) TEG or reception-transmission (RxTx) TEG. Further, aspects presented herein may allow additional Rx samples to be stored in memory and additional processing at the UE when reporting multiple measurements associated with different Rx TEGs per PRS resource.

In some aspects, a UE may advertise various UE capabilities that are associated with the aforementioned measurement period or measuring PRS resources. For instance, a UE may report or advertise a buffering capability to store these various positioning measurements. The buffering capability may be associated with storing/buffering a PRS measurement period of a certain duration, where the measurements are associated with a single TEG. Also, a UE may report or advertise a processing capability to process these various positioning measurements. The processing capability may be associated with processing a number of different PRS resources per slot, where the measurements of each PRS resource are associated with different TEGs. For example, UEs may report or advertise these buffering/processing capabilities to various base stations, TRPs, or network entities (e.g., LMFs).

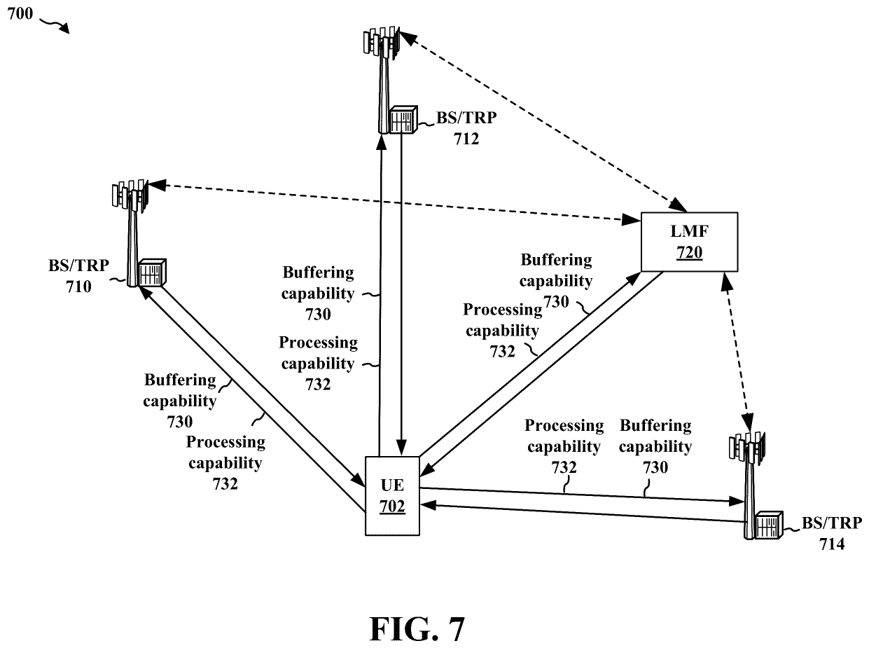

FIG. 7 illustrates diagram 700 including one example of a wireless communication system. More specifically, diagram 700 in FIG. 7 shows an example of a wireless communication system for positioning measurements. As shown in FIG. 7, diagram 700 includes a UE 702, a number of different base stations (BSs) or TRPs (e.g., BS/TRP 710, BS/TRP 712, and BS/TRP 714), and a network entity that is associated with these UEs and BSs/TRPs (e.g., LMF 720). As further depicted in FIG. 7, UE 702 may report or advertise its buffering capabilities (e.g., buffering capability 730) and/or processing capabilities (e.g., processing capability 732) to the various BSs or TRPs. For example, UE 702 may report/advertise its buffering capability 730 to BS/TRP 710, BS/TRP 712, and BS/TRP 714. The buffering capability 730 may be associated with the capability to store various positioning measurements in a buffer/memory at the UE (e.g., a capability of an amount of memory/buffer consumption at the UE). Additionally, UE 702 may report/advertise its processing capability 732 to BS/TRP 710, BS/TRP 712, and BS/TRP 714. The processing capability 732 may be associated with the capability to process various positioning measurements at the UE. Moreover, UE 702 may report/advertise its buffering capability 730 and processing capability 732 to the network or LMF 720.

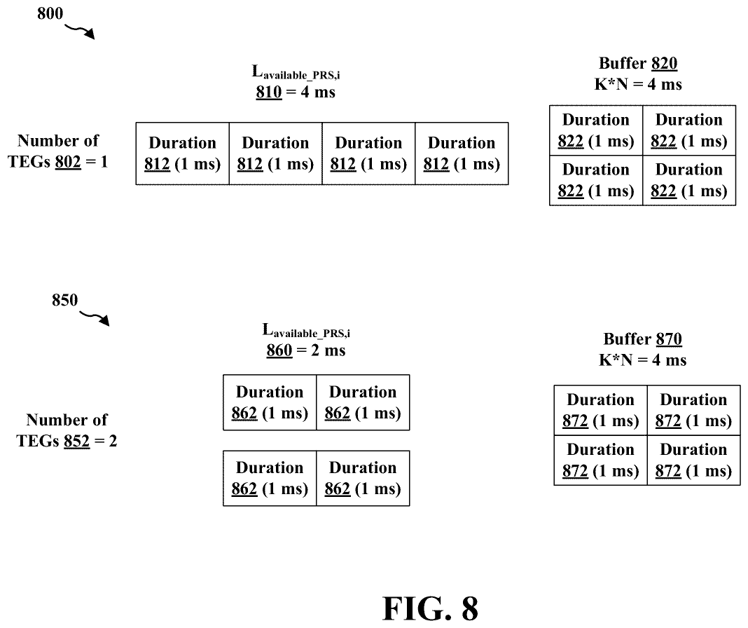

FIG. 8 illustrates diagram 800 and diagram 850 including examples of PRS durations and corresponding buffer amounts. More specifically, diagrams 800 and 850 in FIG. 8 show examples of PRS durations with an amount of TEGs compared to corresponding buffer amounts. As shown in FIG. 8, diagram 800 depicts a number of TEGs 802=1, a PRS duration of L_{available_PRS,i} 810=4 ms, and duration 812=1 ms. Diagram 800 also includes buffer 820=4 ms and corresponding duration 822=1 ms. As shown in diagram 800, if a UE is requested to measure PRS resources that amount to a certain PRS duration with an amount of TEGs (e.g., a PRS duration of L_{available_PRS,i} 810=4 ms with the number of TEGs 802=1), the UE may buffer an equivalent PRS duration (e.g., a PRS duration of M·L_{available_PRS,i}=1 TEG*4 ms=4 ms=buffer 820). The amount of buffer 820 may be compared against the UE's buffering capability K·N, where M·L_{available_PRS,i} 810=K·N (e.g., M L_{available_PRS,i}=1 TEG*4 ms=4 ms=K·N), where K=1 or K is equal to a number of simultaneous measurements per PRS resource associated with different TEGs supported by the UE. As further shown in FIG. 8, diagram 850 depicts a number of TEGs 852=2, a PRS duration of L_{available_PRS,i} 860=2 ms, and duration 862=1 ms. Diagram 850 also includes buffer 870=4 ms and corresponding duration 872=1 ms. As shown in diagram 850, if a UE is requested to measure PRS resources that amount to a certain PRS duration with an amount of TEGs (e.g., a PRS duration of L_{available_PRS,i} 860=2 ms with the number of TEGs 852=2), the UE may buffer an equivalent PRS duration (e.g., a PRS duration of M·L_{available_PRS,i}=2 TEGs*2 ms=4 ms=buffer 870). The amount of buffer 870 may be compared against the UE's buffering capability N, where M·L_{available_PRS,i} 860=N (e.g., M·L_{available_PRS,i}=2 TEGs*2 ms=4 ms=N). As shown in FIG. 8, a UE may use its advertised buffering capability to store a PRS of duration N ms in time, where measurements are associated with a single TEG. Also, as shown in FIG. 8, a UE may use its advertised buffering capability to store a PRS of a shorter duration, where simultaneous measurements are associated with multiple TEGs.

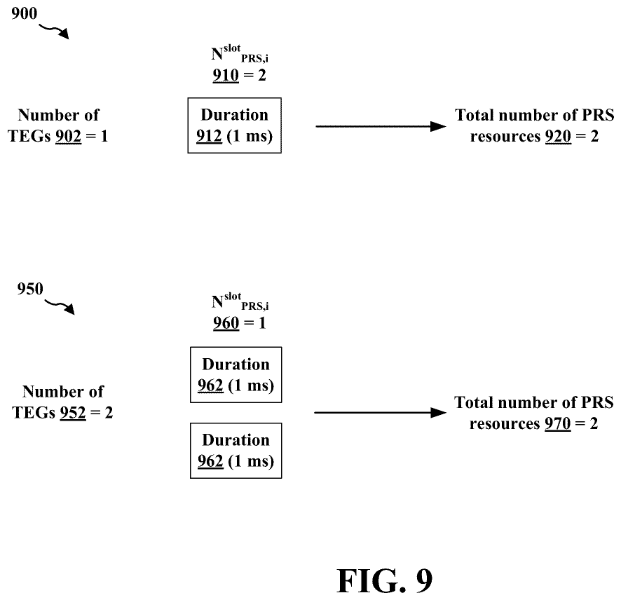

FIG. 9 illustrates diagram 900 and diagram 950 including examples of an amount of PRS resources per slot and corresponding processing capabilities. More specifically, diagrams 900 and 950 in FIG. 9 show examples of an amount of PRS resources per slot with an amount of TEGs compared to corresponding processing capabilities. As shown in FIG. 9, diagram 900 depicts a number of TEGs 902=1, a number of PRS resources per slot N_{PRS,i}^{slot} 910=2, and a corresponding duration 912=1 ms. Diagram 900 also depicts a total number of PRS resources 920=2. As shown in diagram 900, if a UE is requested to process an amount of PRS resources per slot with an amount of TEGs (e.g., an amount of PRS resources per slot NPR 910=2 with a number of TEGs 902=1), then the UE may need a processing capability of a total number of PRS resources (e.g., M·N_{PRS,i}^{slot} 910 PRS resources per slot=1 TEG*2 PRS resources per slot=2=total number of PRS resources 920). As further shown in FIG. 9, diagram 950 depicts a number of TEGs 952=2, a number of PRS resources per slot N_{PRS,i}^{slot} 960=1, and a corresponding duration 962=1 ms. Diagram 950 also includes a total number of PRS resources 970=2. As shown in diagram 950, if a UE is requested to process an amount of PRS resources per slot with an amount of TEGs (e.g., an amount of PRS resources per slot N_{PRS,i}^{slot} 960=1 with a number of TEGs 952=2), then the UE may need a processing capability of a total number of PRS resources (e.g., M·N_{PRS,i}^{slot} 960 PRS resources per slot=2 TEGs*1 PRS resource per slot=2=total number of PRS resources 970). As shown in FIG. 9, a UE may use its advertised processing capability to process K*N′ different PRS resources per slot, where measurements of each PRS resource are associated with a single TEG. Also, as shown in FIG. 9, a UE may use its advertised processing capability to process a single PRS resource per slot, where the resource is measured simultaneously in multiple ways and each measurement is associated with a different TEG.

Aspects of the present disclosure may allow a measurement period to align with a buffering capability of a UE and a processing capability of a UE. In some instances, aspects of the present disclosure may ensure that the measurement period aligns with a buffering capability of a UE and a processing capability of a UE. For instance, aspects presented herein may take into account a UE PRS buffering capability and capability for a number of PRS resources the UE may process per slot, while ensuring that the measurement period does not exceed the UE's capabilities for buffering or processing. More specifically, aspects presented herein may reflect a limitation on the UE's PRS buffering capability and a number of PRS resources the UE may process per slot, while ensuring that the measurement period does not exceed the case when the UE performs the measurements sequentially. Further, aspects of the present disclosure may report or specify the measurement period length for a UE that can support simultaneous measurements without exceeding the UE's PRS processing capabilities or buffering capabilities. In some instances, if a network requests a UE to measure at least one PRS resource with one or more different TEGs and report the corresponding multiple positioning measurements (e.g., RSTD measurements), aspects presented herein may define a corresponding measurement period that does not exceed a processing capability of a UE and/or buffering capability of the UE. For example, if a network (e.g., an LMF) requests a UE to measure a same DL PRS resource of a TRP with M different UE Rx TEGs and report the corresponding multiple RSTD measurements, aspects presented herein may define a corresponding measurement period that is within the processing capabilities and/or buffering capabilities of a UE.

In some instances, aspects presented herein may define a length of a measurement period to be: T_{RSTD,i}=(CSSF_{PRS,i}*N_{RxBeam,i}*X*Nₛₐₘₚₗₑ−1)*T_{effect,i}+T_{last,i}, where T_{RSTD,i} is the length of the measurement period for a positioning frequency layer (PFL), i is a PFL index, CSSF_{PRS,i} is a carrier-specific scaling factor (CSSF) for PRS-based measurements, N_{RxBeam,i} is a UE reception (Rx) beam sweeping factor, Nₛₐₘₚₗₑ is a number of PRS reference signal time difference (RSTD) samples,

$${T}_{effect , i} = ⌈ \frac{{T}_{i}}{{T}_{available\_PRS , i}} ⌉ * {T}_{available\_PRS , i} ,$$

Tᵢ is a time for processing a duration of the PRS resources for the PFL index, T_{available_PRS,i} is a least common multiple between T_{PRS,i} and MGRPᵢ, T_{PRS,i} is an effective PRS periodicity with PRS muting, MGRPᵢ is a measurement gap periodicity, Tₗₐₛₜ is a measurement duration for a last PRS sample, and X is a first variable. In some aspects, the first variable, X, may be defined as follows:

$$X = min ( M ⌈ \frac{{N}_{PRS , i}^{slot}}{{KN}_{i}^{′}} ⌉ ⌈ \frac{{L}_{available\_PRS , i}}{{KN}_{i}} ⌉ , ⌈ \frac{M \cdot {N}_{PRS , i}^{slot}}{{KN}_{i}^{′}} ⌉ ⌈ \frac{M \cdot {L}_{available\_PRS , i}}{{KN}_{i}} ⌉ ) ,$$

where N_{PRS,i}^{slot} is a maximum number of downlink (DL) PRS resources per slot in a time period for a PRS to be measured, M is a number of UE Rx TEGs, Nᵢ is one or more first UE capabilities (e.g., one or more buffer capabilities of the UE) for a duration of PRSs to be processed in Tᵢ, Nᵢ′ is one or more second UE capabilities (e.g., one or more processing capabilities of the UE) for a maximum number of PRS resources per slot to be processed by the UE, L_{available_PRS,i} is a time duration of available PRSs to be measured during T_{available_PRS,i}, and K=1 or K is equal to a number of simultaneous measurements per PRS resource associated with different TEGs supported by the UE. Further, in some aspects, the first variable, X, may be defined as follows:

$$X = {min}_{r ∈ S} ( ⌈ \frac{M}{r} ⌉ ⌈ \frac{r \cdot {N}_{PRS , i}^{slot}}{{KN}_{i}^{′}} ⌉ ⌈ \frac{r \cdot {L}_{available\_PRS , i}}{{KN}_{i}} ⌉ ) ,$$

where S is a subset of {1, 2, . . . , M}, and r is a number of measurements per PRS resource that the UE chooses to perform simultaneously. The minimum specification in the formula above for the first variable X (e.g., “min( )”) allows a UE to minimize any waste in time, storage space, or processing capability to perform certain positioning measurements. By providing a UE with a certain baseline capability to finish processing and storing positioning measurements, aspects presented herein may allow a UE to optimize the amount of time, storage space, or processing capability to perform positioning measurements. As indicated in the formulas above, aspects presented herein may define a measurement period that is within the processing capabilities and/or buffering capabilities of a UE. By doing so, aspects presented herein may ensure that a UE is capable of both processing certain positioning measurements and storing those positioning measurements. In some aspects, the implication of the aforementioned measurement period is that a UE may use the most efficient approach to perform positioning measurements, which accounts for a UE's storage/processing constraints or capabilities.

Aspects of the present disclosure may include a number of benefits or advantages. For instance, aspects presented herein may provide a measurement period that allows UEs to perform positioning measurements within a processing capability of the UE. Also, the aforementioned measurement period may allow UEs to perform positioning measurements within a buffering capability of the UE. By doing so, aspects presented herein may allow UEs to perform positioning measurements within their corresponding processing and buffering capabilities, such that UEs will not exceed their own capabilities in order to perform positioning measurements. For example, by utilizing the aforementioned measurement period, a UE may not be forced to exceed its own processing capabilities and/or buffering capabilities to perform positioning measurements, such as positioning measurements requested by a network (e.g., LMF).

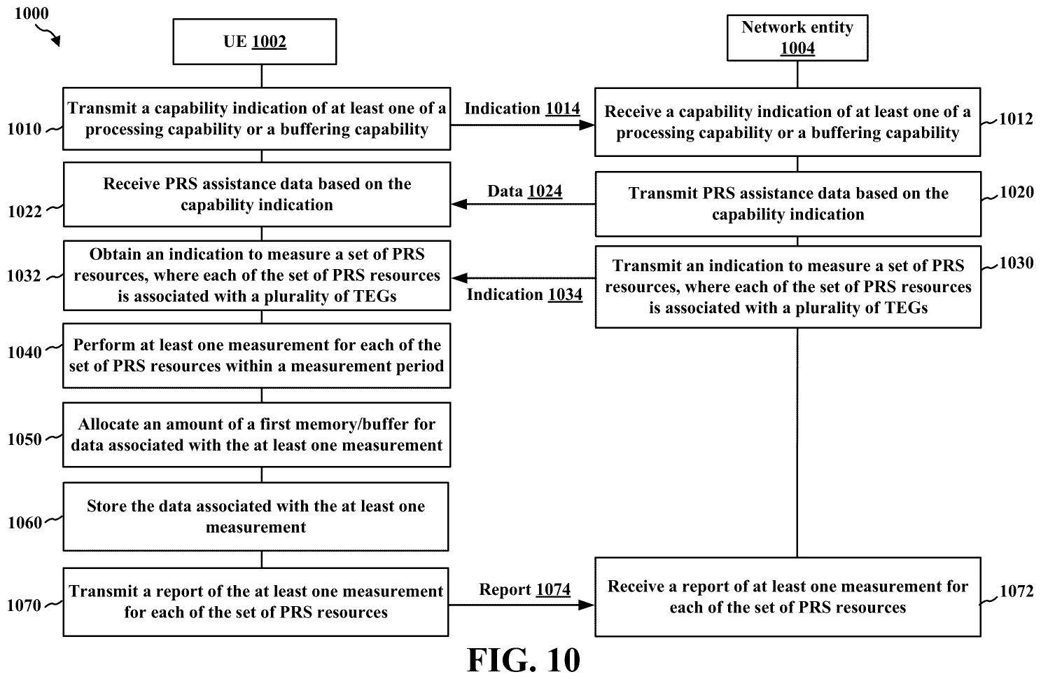

FIG. 10 is a communication flow diagram 1000 of wireless communication in accordance with one or more techniques of this disclosure. As shown in FIG. 10, diagram 1000 includes example communications between UE 1002 and network entity 1004 (e.g., an LMF), in accordance with one or more techniques of this disclosure. In some aspects, UE 1002 may be a first wireless device (e.g., UE, base station, TRP, or network entity) and network entity 1004 may be a second wireless device (e.g., UE, base station, TRP, or network entity).

At 1010, UE 1002 may transmit a capability indication (e.g., indication 1014) to the network entity, where the capability indication indicates at least one of a processing capability of the UE to perform at least one measurement for a set of positioning reference signal (PRS) resources or a buffering capability of the UE to store data associated with the at least one measurement for the set of PRS resources, where the indication is obtained based on the capability indication. At 1012, network entity may receive a capability indication (e.g., indication 1014) from a UE, where the capability indication indicates at least one of a processing capability of the UE to perform at least one measurement for a set of positioning reference signal (PRS) resources or a buffering capability of the UE to store data associated with the at least one measurement for the set of PRS resources, where the indication is transmitted based on the capability indication.

At 1020, network entity may transmit PRS assistance data (e.g., data 1024) based on the capability indication, where the set of PRS resources is based on the PRS assistance data. At 1022, UE 1002 may receive PRS assistance data (e.g., data 1024) based on the capability indication, where the set of PRS resources is based on the PRS assistance data.

At 1030, network entity may transmit an indication (e.g., indication 1034) to measure a set of positioning reference signal (PRS) resources, where a plurality of measurements for each of the set of PRS resources is associated with a plurality of timing error groups (TEGs). At 1032, UE 1002 may obtain an indication (e.g., indication 1034) to measure a set of positioning reference signal (PRS) resources, where each of the set of PRS resources is associated with a plurality of timing error groups (TEGs).

At 1040, UE 1002 may perform, based on the indication, at least one measurement for each of the set of PRS resources, the at least one measurement being performed within a measurement period, where the at least one measurement corresponds to at least one TEG in the plurality of TEGs for each of the set of PRS resources.

In some aspects, a length of the measurement period may correspond to: T_{RSTD,i}=(CSSF_{PRS,i}*N_{RxBeam,i}*X*Nₛₐₘₚₗₑ−1)*T_{effect,i}+T_{last,i}, where T_{RSTD,i} is the length of the measurement period for a positioning frequency layer (PFL), i is a PFL index, CSSF_{PRS,i} is a carrier-specific scaling factor (CSSF) for PRS-based measurements, N_{RxBeam,i} is a UE reception (Rx) beam sweeping factor, Nₛₐₘₚₗₑ is a number of PRS reference signal time difference (RSTD) samples,

$$⌈ \frac{{T}_{i}}{{T}_{available\_PRS , i}} ⌉ * {T}_{available\_PRS , i} ,$$

Tᵢ is a time for processing a duration of the PRS resources for the PFL index, T_{available_PRS,i} is a least common multiple between T_{PRS,i} and MGRPᵢ, T_{PRS,i} is an effective PRS periodicity with PRS muting, MGRPᵢ is a measurement gap periodicity, Tₗₐₛₜ is a measurement duration for a last PRS sample, and X is a first variable. Also, X may be equal to

$$min ( M ⌈ \frac{{N}_{PRS , i}^{slot}}{{KN}_{i}^{′}} ⌉ ⌈ \frac{{L}_{available\_PRS , i}}{{KN}_{i}} ⌉ , ⌈ \frac{M \cdot {N}_{PRS , i}^{slot}}{{KN}_{i}^{′}} ⌉ ⌈ \frac{M \cdot {L}_{available\_PRS , i}}{{KN}_{i}} ⌉ ) ,$$

where N_{PRS,i}^{slot} is a maximum number of downlink (DL) PRS resources per slot in a time period for a PRS to be measured, M is a number of UE Rx TEGs, Nᵢ is one or more first UE capabilities for a duration of PRSs to be processed in Tᵢ, Nᵢ′ is one or more second UE capabilities for a maximum number of PRS resources per slot to be processed by the UE, L_{available_PRS,i} is a time duration of available PRSs to be measured during T_{available_PRS,i}, and K=1 or K is equal to a number of simultaneous measurements per PRS resource associated with different TEGs supported by the UE. Further, X may be equal to

$$⌈ \frac{M \cdot {N}_{PRS , i}^{slot}}{{KN}_{i}^{′}} ⌉ ⌈ \frac{M \cdot {L}_{available\_PRS , i}}{{KN}_{i}} ⌉ ,$$

where N_{PRS,i}^{slot} is a maximum number of downlink (DL) PRS resources per slot, M is a number of UE Rx TEGs, Nᵢ is one or more first UE capabilities for a duration of PRSs to be processed in Tᵢ, Nᵢ′ is one or more second UE capabilities for a maximum number of PRS resources per slot to be processed by the UE, L_{available_PRS,i} is a time duration of available PRSs to be measured during T_{available_PRS,i}, and K=1 or K is equal to a number of simultaneous measurements per PRS resource associated with different TEGs supported by the UE. X may also be equal to

$$⌈ \frac{{N}_{PRS , i}^{slot}}{{KN}_{i}^{′}} ⌉ ⌈ \frac{M \cdot {L}_{available\_PRS , i}}{{KN}_{i}} ⌉ ,$$

where N_{PRS,i}^{slot} is a maximum number of downlink (DL) PRS resources per slot, M is a number of UE Rx TEGs, Nᵢ is one or more first UE capabilities for a duration of PRSs to be processed in Tᵢ, Nᵢ′ is one or more second UE capabilities for a maximum number of PRS resources per slot to be processed by the UE, L_{available_PRS,i} is a time duration of available PRSs to be measured during T_{available_PRS,i}, and K=1 or K is equal to a number of simultaneous measurements per PRS resource associated with different TEGs supported by the UE. Moreover, X may be equal to

$$⌈ \frac{M \cdot {N}_{PRS , i}^{slot}}{{KN}_{i}^{′}} ⌉ ⌈ \frac{{L}_{available\_PRS , i}}{{KN}_{i}} ⌉ ,$$

where N_{PRS,i}^{slot} is a maximum number of downlink (DL) PRS resources per slot, M is a number of UE Rx TEGs, Nᵢ is one or more first UE capabilities for a duration of PRSs to be processed in Tᵢ, Nᵢ′ is one or more second UE capabilities for a maximum number of PRS resources per slot to be processed by the UE, L_{available_PRS,i} is a time duration of available PRSs to be measured during T_{available_PRS,i}, and K=1 or K is equal to a number of simultaneous measurements per PRS resource associated with different TEGs supported by the UE. Also, X may be equal to

$${min}_{r ∈ S} ( ⌈ \frac{M}{r} ⌉ ⌈ \frac{r \cdot {N}_{PRS , i}^{slot}}{{KN}_{i}^{′}} ⌉ ⌈ \frac{r \cdot {L}_{available\_PRS , i}}{{KN}_{i}} ⌉ ) ,$$

where N_{PRS,i}^{slot} is a maximum number of downlink (DL) PRS resources per slot in a time period for a PRS to be measured, M is a number of UE Rx TEGs, Nᵢ is one or more first UE capabilities for a duration of PRSs to be processed in Tᵢ, Nᵢ′ is one or more second UE capabilities for a maximum number of PRS resources per slot to be processed by the UE, L_{available_PRS,i} is a time duration of available PRSs to be measured during T_{available_PRS,i}, K=1 or K is equal to a number of simultaneous measurements per PRS resource associated with different TEGs supported by the UE, S is a subset of {1, 2, . . . , M}, and r is a number of measurements per PRS resource that the UE chooses to perform simultaneously.

Additionally, each of the set of PRS resources may be associated with one transmission-reception point (TRP) in a set of TRPs. The plurality of TEGs may include at least one of: a reception (Rx) TEG or a reception-transmission (Rx-Tx) TEG. Also, the at least one TEG may be associated with a group of measurements, where a relative timing error for a pair of measurements in the group of measurements is within a margin of error. The set of PRS resources may be associated with a same slot in a plurality of slots, such that the at least one measurement is performed for each PRS resource of the set of PRS resources in the same slot. Further, the measurement period may be associated with a timing period during which the UE is expected to perform the at least one measurement. Moreover, obtaining the indication to measure the set of PRS resources may include: receiving a request to measure the set of PRS resources from the network entity.

At 1050, UE 1002 may allocate an amount of a first memory or a first buffer for data associated with the at least one measurement for each of the set of PRS resources.

At 1060, UE 1002 may store the data associated with the at least one measurement for each of the set of PRS resources in the allocated amount of the first memory or the first buffer.

At 1070, UE 1002 may transmit a report (e.g., report 1074) of the at least one measurement for each of the set of PRS resources to a network entity. At 1072, network entity may receive a report (e.g., report 1074) of at least one measurement for each of the set of PRS resources from a user equipment (UE), the at least one measurement being performed within a measurement period, where the at least one measurement corresponds to at least one TEG in the plurality of TEGs for each of the set of PRS resources.

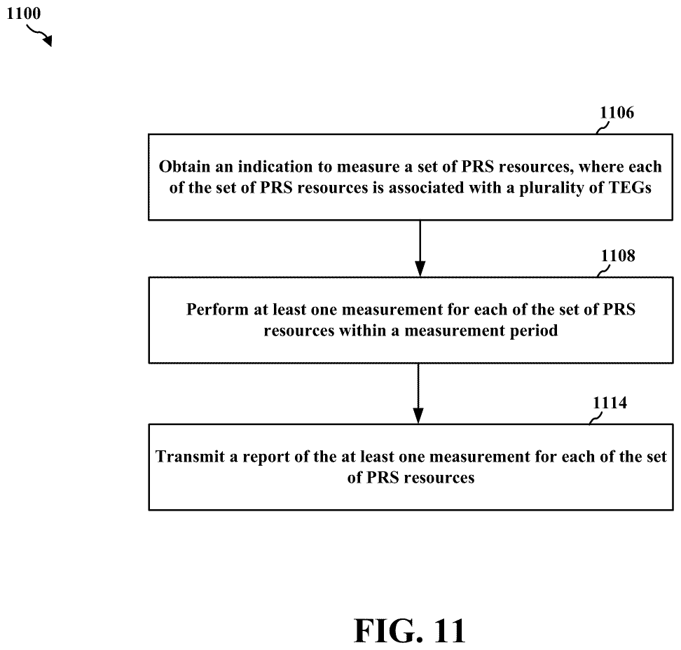

FIG. 11 is a flowchart 1100 of a method of wireless communication. The method may be performed by a UE (e.g., the UE 104, UE 1002; the apparatus 1504). The methods described herein may provide a number of benefits, such as improving resource utilization and/or power savings.

At 1106, the UE may obtain an indication to measure a set of positioning reference signal (PRS) resources, where each of the set of PRS resources is associated with a plurality of timing error groups (TEGs), as discussed with respect to FIGS. 5-10. For example, as described in 1032 of FIG. 10, the UE 1002 may obtain an indication to measure a set of positioning reference signal (PRS) resources, where each of the set of PRS resources is associated with a plurality of timing error groups (TEGs). Further, step 1106 may be performed by measurement component 198.

At 1108, the UE may perform, based on the indication, at least one measurement for each of the set of PRS resources, the at least one measurement being performed within a measurement period, where the at least one measurement corresponds to at least one TEG in the plurality of TEGs for each of the set of PRS resources, as discussed with respect to FIGS. 5-10. For example, as described in 1040 of FIG. 10, the UE 1002 may perform, based on the indication, at least one measurement for each of the set of PRS resources, the at least one measurement being performed within a measurement period, where the at least one measurement corresponds to at least one TEG in the plurality of TEGs for each of the set of PRS resources. Further, step 1108 may be performed by measurement component 198.

In some aspects, a length of the measurement period may correspond to: T_{RSTD,i}=(CSSF_{PRS,i}*N_{RxBeam,i}*X*Nₛₐₘₚₗₑ−1)*T_{effect,i}+T_{last,i}, where T_{RSTD,i} is the length of the measurement period for a positioning frequency layer (PFL), i is a PFL index, CSSF_{PRS,i} is a carrier-specific scaling factor (CSSF) for PRS-based measurements, N_{RxBeam,i} is a UE reception (Rx) beam sweeping factor, Nₛₐₘₚₗₑ is a number of PRS reference signal time difference (RSTD) samples,

$${T}_{effect , i} = ⌈ \frac{{T}_{i}}{{T}_{available\_PRS , i}} ⌉ * {T}_{available\_PRS , i} ,$$

Tᵢ is a time for processing a duration of the PRS resources for the PFL index, T_{available_PRS,i} is a least common multiple between T_{PRS,i} and MGRPᵢ, T_{PRS,i} is an effective PRS periodicity with PRS muting, MGRPᵢ is a measurement gap periodicity, Tₗₐₛₜ is a measurement duration for a last PRS sample, and X is a first variable. Also, X may be equal to

$$min ( M ⌈ \frac{{N}_{PRS , i}^{slot}}{{KN}_{i}^{′}} ⌉ ⌈ \frac{{L}_{available\_PRS , i}}{{KN}_{i}} ⌉ , ⌈ \frac{M \cdot {N}_{PRS , i}^{slot}}{{KN}_{i}^{′}} ⌉ ⌈ \frac{M \cdot {L}_{available\_PRS , i}}{{KN}_{i}} ⌉ ) ,$$

where N_{PRS,i}^{slot} is a maximum number of downlink (DL) PRS resources per slot in a time period for a PRS to be measured, M is a number of UE Rx TEGs, Nᵢ is one or more first UE capabilities for a duration of PRSs to be processed in Tᵢ, Nᵢ′ is one or more second UE capabilities for a maximum number of PRS resources per slot to be processed by the UE, L_{available_PRS,i} is a time duration of available PRSs to be measured during T_{available_PRS,i}, and K=1 or K is equal to a number of simultaneous measurements per PRS resource associated with different TEGs supported by the UE. Further, X may be equal to

$$⌈ \frac{M \cdot {N}_{PRS , i}^{slot}}{{KN}_{i}^{′}} ⌉ ⌈ \frac{M \cdot {L}_{available\_PRS , i}}{{KN}_{i}} ⌉ ,$$

where N_{PRS,i}^{slot} is a maximum number of downlink (DL) PRS resources per slot, M is a number of UE Rx TEGs, Nᵢ is one or more first UE capabilities for a duration of PRSs to be processed in Tᵢ, Nᵢ′ is one or more second UE capabilities for a maximum number of PRS resources per slot to be processed by the UE, L_{available_PRS,i} is a time duration of available PRSs to be measured during T_{available_PRS,i}, and K=1 or K is equal to a number of simultaneous measurements per PRS resource associated with different TEGs supported by the UE. X may also be equal to

$$⌈ \frac{{N}_{PRS , i}^{slot}}{{KN}_{i}^{′}} ⌉ ⌈ \frac{M \cdot {L}_{available\_PRS , i}}{{KN}_{i}} ⌉ ,$$

where N_{PRS,i}^{slot} is a maximum number of downlink (DL) PRS resources per slot, M is a number of UE Rx TEGs, Nᵢ is one or more first UE capabilities for a duration of PRSs to be processed in Tᵢ, Nᵢ′ is one or more second UE capabilities for a maximum number of PRS resources per slot to be processed by the UE, L_{available_PRS,i} is a time duration of available PRSs to be measured during T_{available_PRS,i}, and K=1 or K is equal to a number of simultaneous measurements per PRS resource associated with different TEGs supported by the UE. Moreover, X may be equal to

$$⌈ \frac{{N}_{PRS , i}^{slot}}{{KN}_{i}^{′}} ⌉ ⌈ \frac{{L}_{available\_PRS , i}}{{KN}_{i}} ⌉ ,$$

where N_{PRS,i}^{slot} is a maximum number of downlink (DL) PRS resources per slot, M is a number of UE Rx TEGs, Nᵢ is one or more first UE capabilities for a duration of PRSs to be processed in Tᵢ, Nᵢ′ is one or more second UE capabilities for a maximum number of PRS resources per slot to be processed by the UE, L_{available_PRS,i} is a time duration of available PRSs to be measured during T_{available_PRS,i}, and K=1 or K is equal to a number of simultaneous measurements per PRS resource associated with different TEGs supported by the UE. Also, X may be equal to

$${min}_{r ∈ S} ( ⌈ \frac{M}{r} ⌉ ⌈ \frac{r \cdot {N}_{PRS , i}^{slot}}{{KN}_{i}^{′}} ⌉ ⌈ \frac{r \cdot {L}_{available\_PRS , i}}{{KN}_{i}} ⌉ ) ,$$

where N_{PRS,i}^{slot} is a maximum number of downlink (DL) PRS resources per slot in a time period for a PRS to be measured, M is a number of UE Rx TEGs, Nᵢ is one or more first UE capabilities for a duration of PRSs to be processed in Tᵢ, Nᵢ′ is one or more second UE capabilities for a maximum number of PRS resources per slot to be processed by the UE, L_{available_PRS,i} is a time duration of available PRSs to be measured during T_{available_PRS,i}, K=1 or K is equal to a number of simultaneous measurements per PRS resource associated with different TEGs supported by the UE, S is a subset of {1, 2, . . . , M}, and r is a number of measurements per PRS resource that the UE chooses to perform simultaneously.

Additionally, each of the set of PRS resources may be associated with one transmission-reception point (TRP) in a set of TRPs. The plurality of TEGs may include at least one of: a reception (Rx) TEG or a reception-transmission (Rx-Tx) TEG. Also, the at least one TEG may be associated with a group of measurements, where a relative timing error for a pair of measurements in the group of measurements is within a margin of error. The set of PRS resources may be associated with a same slot in a plurality of slots, such that the at least one measurement is performed for each PRS resource of the set of PRS resources in the same slot. Further, the measurement period may be associated with a timing period during which the UE is expected to perform the at least one measurement. Moreover, obtaining the indication to measure the set of PRS resources may include: receiving a request to measure the set of PRS resources from the network entity.

At 1114, the UE may transmit a report of the at least one measurement for each of the set of PRS resources to a network entity, as discussed with respect to FIGS. 5-10. For example, as described in 1070 of FIG. 10, the UE 1002 may transmit a report of the at least one measurement for each of the set of PRS resources to a network entity. Further, step 1114 may be performed by measurement component 198.

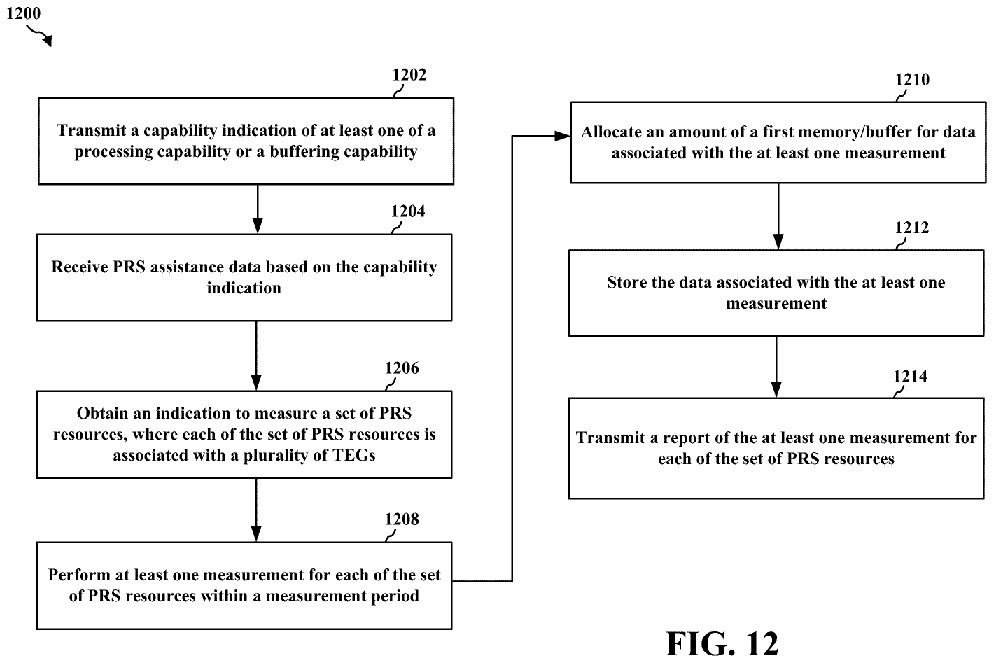

FIG. 12 is a flowchart 1200 of a method of wireless communication. The method may be performed by a UE (e.g., the UE 104, UE 1002; the apparatus 1504). The methods described herein may provide a number of benefits, such as improving resource utilization and/or power savings.

At 1202, the UE may transmit a capability indication to the network entity, where the capability indication indicates at least one of a processing capability of the UE to perform at least one measurement for a set of positioning reference signal (PRS) resources or a buffering capability of the UE to store data associated with the at least one measurement for the set of PRS resources, where an indication is obtained based on the capability indication, as discussed with respect to FIGS. 5-10. For example, as described in 1010 of FIG. 10, the UE 1002 may transmit a capability indication to the network entity, where the capability indication indicates at least one of a processing capability of the UE to perform at least one measurement for a set of positioning reference signal (PRS) resources or a buffering capability of the UE to store data associated with the at least one measurement for the set of PRS resources, where an indication is obtained based on the capability indication. Further, step 1202 may be performed by measurement component 198.

At 1204, the UE may receive PRS assistance data based on the capability indication, where the set of PRS resources is based on the PRS assistance data, as discussed with respect to FIGS. 5-10. For example, as described in 1022 of FIG. 10, the UE 1002 may receive PRS assistance data based on the capability indication, where the set of PRS resources is based on the PRS assistance data. Further, step 1204 may be performed by measurement component 198.

At 1206, the UE may obtain an indication to measure a set of positioning reference signal (PRS) resources, where each of the set of PRS resources is associated with a plurality of timing error groups (TEGs), as discussed with respect to FIGS. 5-10. For example, as described in 1032 of FIG. 10, the UE 1002 may obtain an indication to measure a set of positioning reference signal (PRS) resources, where each of the set of PRS resources is associated with a plurality of timing error groups (TEGs). Further, step 1206 may be performed by measurement component 198.

At 1208, the UE may perform, based on the indication, at least one measurement for each of the set of PRS resources, the at least one measurement being performed within a measurement period, where the at least one measurement corresponds to at least one TEG in the plurality of TEGs for each of the set of PRS resources, as discussed with respect to FIGS. 5-10. For example, as described in 1040 of FIG. 10, the UE 1002 may perform, based on the indication, at least one measurement for each of the set of PRS resources, the at least one measurement being performed within a measurement period, where the at least one measurement corresponds to at least one TEG in the plurality of TEGs for each of the set of PRS resources. Further, step 1208 may be performed by measurement component 198.

In some aspects, a length of the measurement period may correspond to: T_{RSTD,i}=(CSSF_{PRS,i}*N_{RxBeam,i}*X*Nₛₐₘₚₗₑ−1)*T_{effect,i}+T_{last,i}, where T_{RSTD,i} is the length of the measurement period for a positioning frequency layer (PFL), i is a PFL index, CSSF_{PRS,i} is a carrier-specific scaling factor (CSSF) for PRS-based measurements, N_{RxBeam,i} is a UE reception (Rx) beam sweeping factor, Nₛₐₘₚₗₑ is a number of PRS reference signal time difference (RSTD) samples,

$${T}_{effect , i} = ⌈ \frac{{T}_{i}}{{T}_{available\_PRS , i}} ⌉ * {T}_{available\_PRS , i} ,$$

Tᵢ is a time for processing a duration of the PRS resources for the PFL index, T_{available_PRS,i} is a least common multiple between T_{PRS,i} and MGRPᵢ, T_{PRS,i} is an effective PRS periodicity with PRS muting, MGRPᵢ is a measurement gap periodicity, Tₗₐₛₜ is a measurement duration for a last PRS sample, and X is a first variable. Also, X may be equal to

$$min ( M ⌈ \frac{{N}_{PRS , i}^{slot}}{{KN}_{i}^{′}} ⌉ ⌈ \frac{{L}_{available\_PRS , i}}{{KN}_{i}} ⌉ , ⌈ \frac{M \cdot {N}_{PRS , i}^{slot}}{{KN}_{i}^{′}} ⌉ ⌈ \frac{M \cdot {L}_{available\_PRS , i}}{{KN}_{i}} ⌉ ) ,$$

where N_{PRS,i}^{slot} is a maximum number of downlink (DL) PRS resources per slot in a time period for a PRS to be measured, M is a number of UE Rx TEGs, Nᵢ is one or more first UE capabilities for a duration of PRSs to be processed in Tᵢ, Nᵢ′ is one or more second UE capabilities for a maximum number of PRS resources per slot to be processed by the UE, L_{available_PRS,i} is a time duration of available PRSs to be measured during T_{available_PRS,i}, and K=1 or K is equal to a number of simultaneous measurements per PRS resource associated with different TEGs supported by the UE. Further, X may be equal to

$$⌈ \frac{M \cdot {N}_{PRS , i}^{slot}}{{KN}_{i}^{′}} ⌉ ⌈ \frac{M \cdot {L}_{available\_PRS , i}}{{KN}_{i}} ⌉ ,$$

where N_{PRS,i}^{slot} is a maximum number of downlink (DL) PRS resources per slot, M is a number of UE Rx TEGs, Nᵢ is one or more first UE capabilities for a duration of PRSs to be processed in Tᵢ, Nᵢ′ is one or more second UE capabilities for a maximum number of PRS resources per slot to be processed by the UE, L_{available_PRS,i} is a time duration of available PRSs to be measured during T_{available_PRS,i}, and K=1 or K is equal to a number of simultaneous measurements per PRS resource associated with different TEGs supported by the UE. X may also be equal to

$$⌈ \frac{{N}_{PRS , i}^{slot}}{{KN}_{i}^{′}} ⌉ ⌈ \frac{M \cdot {L}_{available\_PRS , i}}{{KN}_{i}} ⌉ ,$$

where N_{PRS,i}^{slot} is a maximum number of downlink (DL) PRS resources per slot, M is a number of UE Rx TEGs, Nᵢ is one or more first UE capabilities for a duration of PRSs to be processed in Tᵢ, Nᵢ′ is one or more second UE capabilities for a maximum number of PRS resources per slot to be processed by the UE, L_{available_PRS,i} is a time duration of available PRSs to be measured during T_{available_PRS,i}, and K=1 or K is equal to a number of simultaneous measurements per PRS resource associated with different TEGs supported by the UE. Moreover, X may be equal to

$$⌈ \frac{M \cdot {N}_{PRS , i}^{slot}}{{KN}_{i}^{′}} ⌉ ⌈ \frac{{L}_{available\_PRS , i}}{{KN}_{i}} ⌉ ,$$

where N_{PRS,i}^{slot} is a maximum number of downlink (DL) PRS resources per slot, M is a number of UE Rx TEGs, Nᵢ is one or more first UE capabilities for a duration of PRSs to be processed in Tᵢ, Nᵢ′ is one or more second UE capabilities for a maximum number of PRS resources per slot to be processed by the UE, L_{available_PRS,i} is a time duration of available PRSs to be measured during T_{available_PRS,i}, and K=1 or K is equal to a number of simultaneous measurements per PRS resource associated with different TEGs supported by the UE. Also, X may be equal to

$${min}_{r ∈ S} ( ⌈ \frac{M}{r} ⌉ ⌈ \frac{r \cdot {N}_{PRS , i}^{slot}}{{KN}_{i}^{′}} ⌉ ⌈ \frac{r \cdot {L}_{available\_PRS , i}}{{KN}_{i}} ⌉ ) ,$$

where N_{PRS,i}^{slot} is a maximum number of downlink (DL) PRS resources per slot in a time period for a PRS to be measured, M is a number of UE Rx TEGs, Nᵢ is one or more first UE capabilities for a duration of PRSs to be processed in Tᵢ, Nᵢ′ is one or more second UE capabilities for a maximum number of PRS resources per slot to be processed by the UE, L_{available_PRS,i} is a time duration of available PRSs to be measured during T_{available_PRS,i}, K=1 or K is equal to a number of simultaneous measurements per PRS resource associated with different TEGs supported by the UE, S is a subset of {1, 2, . . . , M}, and r is a number of measurements per PRS resource that the UE chooses to perform simultaneously.

Additionally, each of the set of PRS resources may be associated with one transmission-reception point (TRP) in a set of TRPs. The plurality of TEGs may include at least one of: a reception (Rx) TEG or a reception-transmission (Rx-Tx) TEG. Also, the at least one TEG may be associated with a group of measurements, where a relative timing error for a pair of measurements in the group of measurements is within a margin of error. The set of PRS resources may be associated with a same slot in a plurality of slots, such that the at least one measurement is performed for each PRS resource of the set of PRS resources in the same slot. Further, the measurement period may be associated with a timing period during which the UE is expected to perform the at least one measurement. Moreover, obtaining the indication to measure the set of PRS resources may include: receiving a request to measure the set of PRS resources from the network entity.

At 1210, the UE may allocate an amount of a first memory or a first buffer for data associated with the at least one measurement for each of the set of PRS resources, as discussed with respect to FIGS. 5-10. For example, as described in 1050 of FIG. 10, the UE 1002 may allocate an amount of a first memory or a first buffer for data associated with the at least one measurement for each of the set of PRS resources. Further, step 1210 may be performed by measurement component 198.

At 1212, the UE may store the data associated with the at least one measurement for each of the set of PRS resources in the allocated amount of the first memory or the first buffer, as discussed with respect to FIGS. 5-10. For example, as described in 1060 of FIG. 10, the UE 1002 may store the data associated with the at least one measurement for each of the set of PRS resources in the allocated amount of the first memory or the first buffer. Further, step 1212 may be performed by measurement component 198.

At 1214, the UE may transmit a report of the at least one measurement for each of the set of PRS resources to a network entity, as discussed with respect to FIGS. 5-10. For example, as described in 1070 of FIG. 10, the UE 1002 may transmit a report of the at least one measurement for each of the set of PRS resources to a network entity. Further, step 1214 may be performed by measurement component 198.

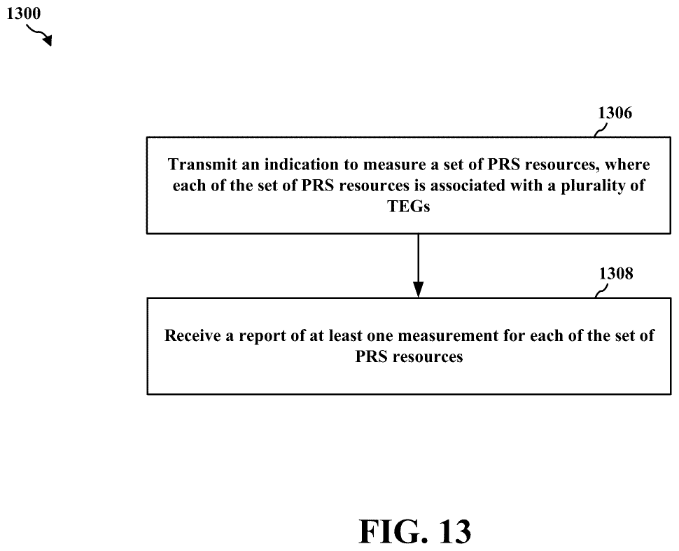

FIG. 13 is a flowchart 1300 of a method of wireless communication. The method may be performed by a network entity (e.g., LMF 166; network entity 1004; the network entity 1760) or a base station (e.g., the base station 102; the network entity 1602). The methods described herein may provide a number of benefits, such as improving resource utilization and/or power savings.

At 1306, the network entity may transmit an indication to measure a set of positioning reference signal (PRS) resources, where each of the set of PRS resources is associated with a plurality of timing error groups (TEGs), as discussed with respect to FIGS. 5-10. For example, as described in 1030 of FIG. 10, the network entity may transmit an indication to measure a set of positioning reference signal (PRS) resources, where each of the set of PRS resources is associated with a plurality of timing error groups (TEGs). Further, step 1306 may be performed by measurement component 199.

In some aspects, a length of the measurement period may correspond to: T_{RSTD,i}=(CSSF_{PRS,i}*N_{RxBeam,i}*X*Nₛₐₘₚₗₑ−1)*T_{effect,i}+T_{last,i}, where T_{RSTD,i} is the length of the measurement period for a positioning frequency layer (PFL), i is a PFL index, CSSF_{PRS,i} is a carrier-specific scaling factor (CSSF) for PRS-based measurements, N_{RxBeam,i} is a UE reception (Rx) beam sweeping factor, Nₛₐₘₚₗₑ is a number of PRS reference signal time difference (RSTD) samples,

$${T}_{effect , i} = ⌈ \frac{{T}_{i}}{{T}_{available\_PRS , i}} ⌉ * {T}_{availabile\_PRS , i ,}$$

Tᵢ is a time for processing a duration of the PRS resources for the PFL index, T_{available_PRS,i} is a least common multiple between T_{PRS,i} and MGRPᵢ, T_{PRS,i} is an effective PRS periodicity with PRS muting, MGRPᵢ is a measurement gap periodicity, Tₗₐₛₜ is a measurement duration for a last PRS sample, and X is a first variable. Also, X may be equal to

$$min ( M ⌈ \frac{{N}_{PRS , i}^{slot}}{{KN}_{i}^{′}} ⌉ ⌈ \frac{{L}_{available\_PRS , i}}{{KN}_{i}} ⌉ , ⌈ \frac{M \cdot {N}_{PRS , i}^{slot}}{{KN}_{i}^{′}} ⌉ ⌈ \frac{M \cdot {L}_{available\_PRS , i}}{{KN}_{i}} ⌉ ) ,$$

where N_{PRS,i}^{slot} is a maximum number of downlink (DL) PRS resources per slot in a time period for a PRS to be measured, M is a number of UE Rx TEGs, Nᵢ is one or more first UE capabilities for a duration of PRSs to be processed in Tᵢ, Nᵢ′ is one or more second UE capabilities for a maximum number of PRS resources per slot to be processed by the UE, L_{available_PRS,i} is a time duration of available PRSs to be measured during T_{available_PRS,i}, and K=1 or K is equal to a number of simultaneous measurements per PRS resource associated with different TEGs supported by the UE. Further, X may be equal to

$$⌈ \frac{M \cdot {N}_{PRS , i}^{slot}}{{KN}_{i}^{′}} ⌉ ⌈ \frac{M \cdot {L}_{available\_PRS , i}}{{KN}_{i}} ⌉ ,$$

where N_{PRS,i}^{slot} is a maximum number of downlink (DL) PRS resources per slot, M is a number of UE Rx TEGs, Nᵢ is one or more first UE capabilities for a duration of PRSs to be processed in Tᵢ, Nᵢ′ is one or more second UE capabilities for a maximum number of PRS resources per slot to be processed by the UE, L_{available_PRS,i} is a time duration of available PRSs to be measured during T_{available_PRS,i}, and K=1 or K is equal to a number of simultaneous measurements per PRS resource associated with different TEGs supported by the UE. X may also be equal to

$$⌈ \frac{{N}_{PRS , i}^{slot}}{{KN}_{i}^{′}} ⌉ ⌈ \frac{M \cdot {L}_{available\_PRS , i}}{{KN}_{i}} ⌉ ,$$

where N_{PRS,i}^{slot} is a maximum number of downlink (DL) PRS resources per slot, M is a number of UE Rx TEGs, Nᵢ is one or more first UE capabilities for a duration of PRSs to be processed in Tᵢ, Nᵢ′ is one or more second UE capabilities for a maximum number of PRS resources per slot to be processed by the UE, L_{available_PRS,i} is a time duration of available PRSs to be measured during T_{available_PRS,i}, and K=1 or K is equal to a number of simultaneous measurements per PRS resource associated with different TEGs supported by the UE. Moreover, X may be equal to

$$⌈ \frac{M \cdot {N}_{PRS , i}^{slot}}{{KN}_{i}^{′}} ⌉ ⌈ \frac{{L}_{available\_PRS , i}}{{KN}_{i}} ⌉ ,$$

where N_{PRS,i}^{slot} is a maximum number of downlink (DL) PRS resources per slot, M is a number of UE Rx TEGs, Nᵢ is one or more first UE capabilities for a duration of PRSs to be processed in Tᵢ, Nᵢ′ is one or more second UE capabilities for a maximum number of PRS resources per slot to be processed by the UE, L_{available_PRS,i} is a time duration of available PRSs to be measured during T_{available_PRS,i}, and K=1 or K is equal to a number of simultaneous measurements per PRS resource associated with different TEGs supported by the UE. Also, X may be equal to

$${min}_{r ∈ S} ( ⌈ \frac{M}{r} ⌉ ⌈ \frac{r \cdot {N}_{PRS , i}^{slot}}{{KN}_{i}^{′}} ⌉ ⌈ \frac{r \cdot {L}_{available\_PRS , i}}{{KN}_{i}} ⌉ ) ,$$

where N_{PRS,i}^{slot} is a maximum number of downlink (DL) PRS resources per slot in a time period for a PRS to be measured, M is a number of UE Rx TEGs, Nᵢ is one or more first UE capabilities for a duration of PRSs to be processed in Tᵢ, Nᵢ′ is one or more second UE capabilities for a maximum number of PRS resources per slot to be processed by the UE, L_{available_PRS,i} is a time duration of available PRSs to be measured during T_{available_PRS,i}, K=1 or K is equal to a number of simultaneous measurements per PRS resource associated with different TEGs supported by the UE, S is a subset of {1, 2, . . . , M}, and r is a number of measurements per PRS resource that the UE chooses to perform simultaneously.

Additionally, each of the set of PRS resources may be associated with one transmission-reception point (TRP) in a set of TRPs. The plurality of TEGs may include at least one of: a reception (Rx) TEG or a reception-transmission (Rx-Tx) TEG. Also, the at least one TEG may be associated with a group of measurements, where a relative timing error for a pair of measurements in the group of measurements is within a margin of error. The set of PRS resources may be associated with a same slot in a plurality of slots, such that the at least one measurement is performed for each PRS resource of the set of PRS resources in the same slot. Further, the measurement period may be associated with a timing period during which the UE is expected to perform the at least one measurement.

At 1308, the network entity may receive a report of at least one measurement for each of the set of PRS resources from a user equipment (UE), the at least one measurement being performed within a measurement period, where the at least one measurement corresponds to at least one TEG in the plurality of TEGs for each of the set of PRS resources, as discussed with respect to FIGS. 5-10. For example, as described in 1072 of FIG. 10, the network entity may receive a report of at least one measurement for each of the set of PRS resources from a user equipment (UE), the at least one measurement being performed within a measurement period, where the at least one measurement corresponds to at least one TEG in the plurality of TEGs for each of the set of PRS resources. Further, step 1308 may be performed by measurement component 199.

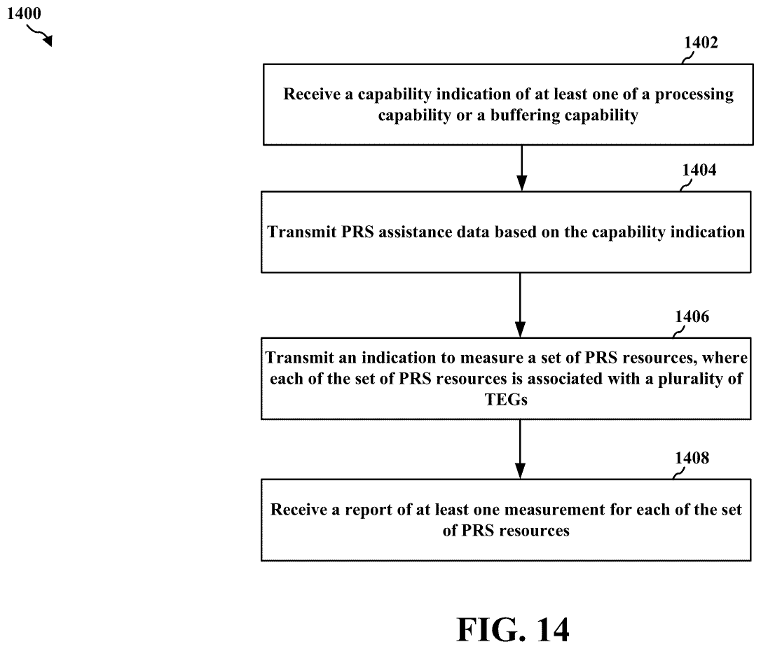

FIG. 14 is a flowchart 1400 of a method of wireless communication. The method may be performed by a network entity (e.g., LMF 166; network entity 1004; the network entity 1760) or a base station (e.g., the base station 102; the network entity 1602). The methods described herein may provide a number of benefits, such as improving resource utilization and/or power savings.

At 1402, the network entity may receive a capability indication from a UE, where the capability indication indicates at least one of a processing capability of the UE to perform at least one measurement for a set of positioning reference signal (PRS) resources or a buffering capability of the UE to store data associated with the at least one measurement for the set of PRS resources, where the indication is transmitted based on the capability indication, as discussed with respect to FIGS. 5-10. For example, as described in 1012 of FIG. 10, the network entity may receive a capability indication from a UE, where the capability indication indicates at least one of a processing capability of the UE to perform at least one measurement for a set of positioning reference signal (PRS) resources or a buffering capability of the UE to store data associated with the at least one measurement for the set of PRS resources, where the indication is transmitted based on the capability indication. Further, step 1402 may be performed by measurement component 199.

At 1404, the network entity may transmit PRS assistance data based on the capability indication, where the set of PRS resources is based on the PRS assistance data, as discussed with respect to FIGS. 5-10. For example, as described in 1020 of FIG. 10, the network entity may transmit PRS assistance data based on the capability indication, where the set of PRS resources is based on the PRS assistance data. Further, step 1404 may be performed by measurement component 199.

At 1406, the network entity may transmit an indication to measure a set of positioning reference signal (PRS) resources, where each of the set of PRS resources is associated with a plurality of timing error groups (TEGs), as discussed with respect to FIGS. 5-10. For example, as described in 1030 of FIG. 10, the network entity may transmit an indication to measure a set of positioning reference signal (PRS) resources, where each of the set of PRS resources is associated with a plurality of timing error groups (TEGs). Further, step 1406 may be performed by measurement component 199.

In some aspects, a length of the measurement period may correspond to: T_{RSTD,i}=(CSSF_{PRS,i}*N_{RxBeam,i}*X*Nₛₐₘₚₗₑ−1)*T_{effect,i}+T_{last,i}, where T_{RSTD,i} is the length of the measurement period for a positioning frequency layer (PFL), i is a PFL index, CSSF_{PRS,i} is a carrier-specific scaling factor (CSSF) for PRS-based measurements, N_{RxBeam,i} is a UE reception (Rx) beam sweeping factor, Nₛₐₘₚₗₑ is a number of PRS reference signal time difference (RSTD) samples,

$${T}_{effect , i} = ⌈ \frac{{T}_{i}}{{T}_{a v ailable \_ PRS , i}} ⌉ * {T}_{available \_ PRS , i} ,$$

Tᵢ is a time for processing a duration of the PRS resources for the PFL index, T_{available_PRS,i} is a least common multiple between T_{PRS,i} and MGRPᵢ, T_{PRS,i} is an effective PRS periodicity with PRS muting, MGRPᵢ is a measurement gap periodicity, Tₗₐₛₜ is a measurement duration for a last PRS sample, and X is a first variable. Also, X may be equal to

$$min ( M ⌈ \frac{{N}_{PRS , i}^{s l o t}}{K {N}_{i}^{′}} ⌉ ⌈ \frac{{L}_{available \_ PRS , i}}{K {N}_{i}} ⌉ , ⌈ \frac{M \cdot {N}_{PRS , i}^{s l o t}}{{KN}_{i}^{′}} ⌉ ⌈ \frac{M \cdot {L}_{available \_ PRS , i}}{K {N}_{i}} ⌉ ) ,$$

where N_{PRS,i}^{slot} is a maximum number of downlink (DL) PRS resources per slot in a time period for a PRS to be measured, M is a number of UE Rx TEGs, Nᵢ is one or more first UE capabilities for a duration of PRSs to be processed in Tᵢ, Nᵢ′ is one or more second UE capabilities for a maximum number of PRS resources per slot to be processed by the UE, L_{available_PRS,i} is a time duration of available PRSs to be measured during T_{available_PRS,i}, and K=1 or K is equal to a number of simultaneous measurements per PRS resource associated with different TEGs supported by the UE. Further, X may be equal to

$$⌈ \frac{M \cdot {N}_{PRS , i}^{s l o t}}{{KN}_{i}^{′}} ⌉ ⌈ \frac{M \cdot {L}_{available \_ PRS , i}}{K {N}_{i}} ⌉ ,$$

where N_{PRS,i}^{slot} is a maximum number of downlink (DL) PRS resources per slot, M is a number of UE Rx TEGs, Nᵢ is one or more first UE capabilities for a duration of PRSs to be processed in Tᵢ, Nᵢ′ is one or more second UE capabilities for a maximum number of PRS resources per slot to be processed by the UE, L_{available_PRS,i} is a time duration of available PRSs to be measured during T_{available_PRS,i}, and K=1 or K is equal to a number of simultaneous measurements per PRS resource associated with different TEGs supported by the UE. X may also be equal to

$$⌈ \frac{{N}_{PRS , i}^{s l o t}}{{KN}_{i}^{′}} ⌉ ⌈ \frac{M \cdot {L}_{available \_ PRS , i}}{K {N}_{i}} ⌉ ,$$

where N_{PRS,i}^{slot} is a maximum number of downlink (DL) PRS resources per slot, M is a number of UE Rx TEGs, Nᵢ is one or more first UE capabilities for a duration of PRSs to be processed in Tᵢ, Nᵢ′ is one or more second UE capabilities for a maximum number of PRS resources per slot to be processed by the UE, L_{available_PRS,i} is a time duration of available PRSs to be measured during T_{available_PRS,i}, and K=1 or K is equal to a number of simultaneous measurements per PRS resource associated with different TEGs supported by the UE. Moreover, X may be equal to

$$⌈ \frac{M \cdot {N}_{PRS , i}^{s l o t}}{{KN}_{i}^{′}} ⌉ ⌈ \frac{{L}_{available \_ PRS , i}}{K {N}_{i}} ⌉ ,$$

where N_{PRS,i}^{slot} is a maximum number of downlink (DL) PRS resources per slot, M is a number of UE Rx TEGs, Nᵢ is one or more first UE capabilities for a duration of PRSs to be processed in Tᵢ, Nᵢ′ is one or more second UE capabilities for a maximum number of PRS resources per slot to be processed by the UE, L_{available_PRS,i} is a time duration of available PRSs to be measured during T_{available_PRS,i}, and K=1 or K is equal to a number of simultaneous measurements per PRS resource associated with different TEGs supported by the UE. Also, X may be equal to

$${min}_{r ∈ S} ( ⌈ \frac{M}{r} ⌉ ⌈ \frac{r \cdot {N}_{PRS , i}^{s l o t}}{{KN}_{i}^{′}} ⌉ ⌈ \frac{r \cdot {L}_{available \_ PRS , i}}{K {N}_{i}} ⌉ ) ,$$

where N_{PRS,i}^{slot} is a maximum number of downlink (DL) PRS resources per slot in a time period for a PRS to be measured, M is a number of UE Rx TEGs, Nᵢ is one or more first UE capabilities for a duration of PRSs to be processed in Tᵢ, Nᵢ′ is one or more second UE capabilities for a maximum number of PRS resources per slot to be processed by the UE, L_{available_PRS,i} is a time duration of available PRSs to be measured during T_{available_PRS,i}, K=1 or K is equal to a number of simultaneous measurements per PRS resource associated with different TEGs supported by the UE, S is a subset of {1, 2, . . . , M}, and r is a number of measurements per PRS resource that the UE chooses to perform simultaneously.

Additionally, each of the set of PRS resources may be associated with one transmission-reception point (TRP) in a set of TRPs. The plurality of TEGs may include at least one of: a reception (Rx) TEG or a reception-transmission (Rx-Tx) TEG. Also, the at least one TEG may be associated with a group of measurements, where a relative timing error for a pair of measurements in the group of measurements is within a margin of error. The set of PRS resources may be associated with a same slot in a plurality of slots, such that the at least one measurement is performed for each PRS resource of the set of PRS resources in the same slot. Further, the measurement period may be associated with a timing period during which the UE is expected to perform the at least one measurement.

At 1408, the network entity may receive a report of at least one measurement for each of the set of PRS resources from a user equipment (UE), the at least one measurement being performed within a measurement period, where the at least one measurement corresponds to at least one TEG in the plurality of TEGs for each of the set of PRS resources, as discussed with respect to FIGS. 5-10. For example, as described in 1072 of FIG. 10, the network entity may receive a report of at least one measurement for each of the set of PRS resources from a user equipment (UE), the at least one measurement being performed within a measurement period, where the at least one measurement corresponds to at least one TEG in the plurality of TEGs for each of the set of PRS resources. Further, step 1408 may be performed by measurement component 199.

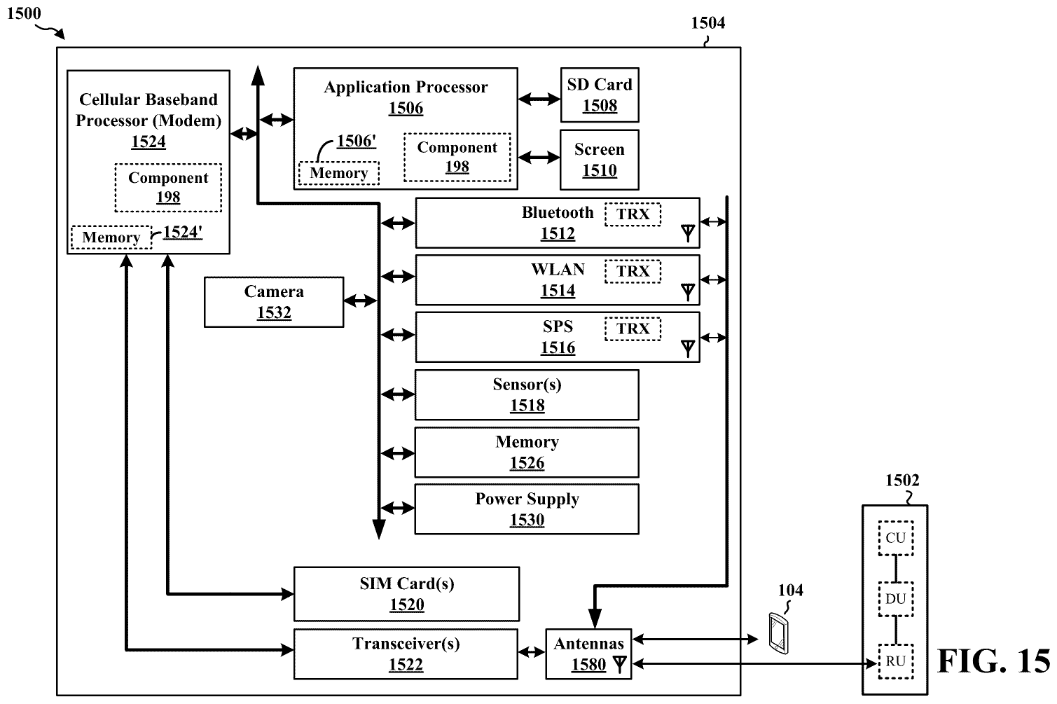

FIG. 15 is a diagram 1500 illustrating an example of a hardware implementation for an apparatus 1504. The apparatus 1504 may be a UE, a component of a UE, or may implement UE functionality. In some aspects, the apparatus 1504 may include a cellular baseband processor 1524 (also referred to as a modem) coupled to one or more transceivers 1522 (e.g., cellular RF transceiver). The cellular baseband processor 1524 may include on-chip memory 1524′. In some aspects, the apparatus 1504 may further include one or more subscriber identity modules (SIM) cards 1520 and an application processor 1506 coupled to a secure digital (SD) card 1508 and a screen 1510. The application processor 1506 may include on-chip memory 1506′. In some aspects, the apparatus 1504 may further include a Bluetooth module 1512, a WLAN module 1514, an SPS module 1516 (e.g., GNSS module), one or more sensor modules 1518 (e.g., barometric pressure sensor/altimeter; motion sensor such as inertial management unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1526, a power supply 1530, and/or a camera 1532. The Bluetooth module 1512, the WLAN module 1514, and the SPS module 1516 may include an on-chip transceiver (TRX) (or in some cases, just a receiver (RX)). The Bluetooth module 1512, the WLAN module 1514, and the SPS module 1516 may include their own dedicated antennas and/or utilize the antennas 1580 for communication. The cellular baseband processor 1524 communicates through the transceiver(s) 1522 via one or more antennas 1580 with the UE 104 and/or with an RU associated with a network entity 1502. The cellular baseband processor 1524 and the application processor 1506 may each include a computer-readable medium/memory 1524′, 1506′, respectively. The additional memory modules 1526 may also be considered a computer-readable medium/memory. Each computer-readable medium/memory 1524′, 1506′, 1526 may be non-transitory. The cellular baseband processor 1524 and the application processor 1506 are each responsible for general processing, including the execution of software stored on the computer-readable medium/memory. The software, when executed by the cellular baseband processor 1524/application processor 1506, causes the cellular baseband processor 1524/application processor 1506 to perform the various functions described supra. The computer-readable medium/memory may also be used for storing data that is manipulated by the cellular baseband processor 1524/application processor 1506 when executing software. The cellular baseband processor 1524/application processor 1506 may be a component of the UE 350 and may include the memory 360 and/or at least one of the TX processor 368, the RX processor 356, and the controller/processor 359. In one configuration, the apparatus 1504 may be a processor chip (modem and/or application) and include just the cellular baseband processor 1524 and/or the application processor 1506, and in another configuration, the apparatus 1504 may be the entire UE (e.g., see 350 of FIG. 3) and include the additional modules of the apparatus 1504.

As discussed supra, the measurement component 198 may be configured to obtain an indication to measure a set of positioning reference signal (PRS) resources, where each of the set of PRS resources is associated with a plurality of timing error groups (TEGs). The measurement component 198 may also be configured to perform, based on the indication, at least one measurement for each of the set of PRS resources, the at least one measurement being performed within a measurement period, where the at least one measurement corresponds to at least one TEG in the plurality of TEGs for each of the set of PRS resources. The measurement component 198 may also be configured to transmit a report of the at least one measurement for each of the set of PRS resources to a network entity. The measurement component 198 may also be configured to transmit a capability indication to the network entity, where the capability indication indicates at least one of a processing capability of the UE to perform the at least one measurement for the set of PRS resources or a buffering capability of the UE to store data associated with the at least one measurement for the set of PRS resources, where the indication is obtained based on the capability indication. The measurement component 198 may also be configured to receive PRS assistance data based on the capability indication, where the set of PRS resources is based on the PRS assistance data. The measurement component 198 may also be configured to allocate an amount of a first memory or a first buffer for data associated with the at least one measurement for each of the set of PRS resources. The measurement component 198 may also be configured to store the data associated with the at least one measurement for each of the set of PRS resources in the allocated amount of the first memory or the first buffer.

The measurement component 198 may be within the cellular baseband processor 1524, the application processor 1506, or both the cellular baseband processor 1524 and the application processor 1506. The measurement component 198 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 1504 may include a variety of components configured for various functions. In one configuration, the apparatus 1504, and in particular the cellular baseband processor 1524 and/or the application processor 1506, includes means for obtaining an indication to measure a set of positioning reference signal (PRS) resources, where each of the set of PRS resources is associated with a plurality of timing error groups (TEGs). The apparatus 1504 may also include means for performing, based on the indication, at least one measurement for each of the set of PRS resources, the at least one measurement being performed within a measurement period, where the at least one measurement corresponds to at least one TEG in the plurality of TEGs for each of the set of PRS resources. The apparatus 1504 may also include means for transmitting a report of the at least one measurement for each of the set of PRS resources to a network entity. The apparatus 1504 may also include means for transmitting a capability indication to the network entity, where the capability indication indicates at least one of a processing capability of the UE to perform the at least one measurement for the set of PRS resources or a buffering capability of the UE to store data associated with the at least one measurement for the set of PRS resources, where the indication is obtained based on the capability indication. The apparatus 1504 may also include means for receiving PRS assistance data based on the capability indication, where the set of PRS resources is based on the PRS assistance data. The apparatus 1504 may also include means for allocating an amount of a first memory or a first buffer for data associated with the at least one measurement for each of the set of PRS resources. The apparatus 1504 may also include means for storing the data associated with the at least one measurement for each of the set of PRS resources in the allocated amount of the first memory or the first buffer. The means may be the measurement component 198 of the apparatus 1504 configured to perform the functions recited by the means. As described supra, the apparatus 1504 may include the TX processor 368, the RX processor 356, and the controller/processor 359. As such, in one configuration, the means may be the TX processor 368, the RX processor 356, and/or the controller/processor 359 configured to perform the functions recited by the means.

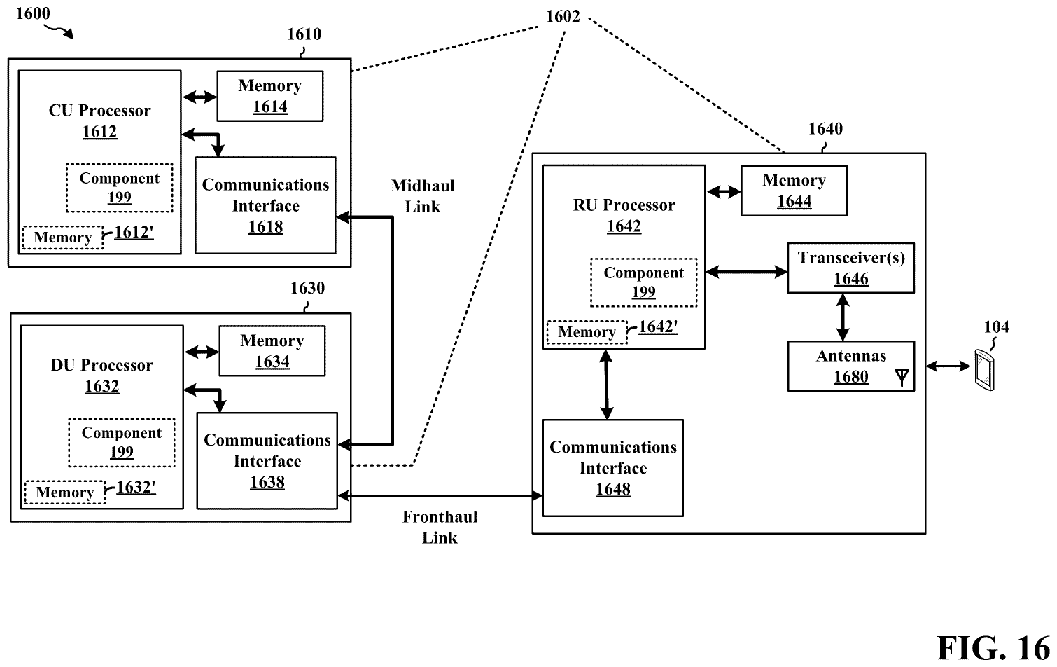

FIG. 16 is a diagram 1600 illustrating an example of a hardware implementation for a network entity 1602. The network entity 1602 may be a BS, a component of a BS, or may implement BS functionality. The network entity 1602 may include at least one of a CU 1610, a DU 1630, or an RU 1640. For example, depending on the layer functionality handled by the measurement component 199, the network entity 1602 may include the CU 1610; both the CU 1610 and the DU 1630; each of the CU 1610, the DU 1630, and the RU 1640; the DU 1630; both the DU 1630 and the RU 1640; or the RU 1640. The CU 1610 may include a CU processor 1612. The CU processor 1612 may include on-chip memory 1612′. In some aspects, the CU 1610 may further include additional memory modules 1614 and a communications interface 1618. The CU 1610 communicates with the DU 1630 through a midhaul link, such as an F1 interface. The DU 1630 may include a DU processor 1632. The DU processor 1632 may include on-chip memory 1632′. In some aspects, the DU 1630 may further include additional memory modules 1634 and a communications interface 1638. The DU 1630 communicates with the RU 1640 through a fronthaul link. The RU 1640 may include an RU processor 1642. The RU processor 1642 may include on-chip memory 1642′. In some aspects, the RU 1640 may further include additional memory modules 1644, one or more transceivers 1646, antennas 1680, and a communications interface 1648. The RU 1640 communicates with the UE 104. The on-chip memory 1612′, 1632′, 1642′ and the additional memory modules 1614, 1634, 1644 may each be considered a computer-readable medium/memory. Each computer-readable medium/memory may be non-transitory. Each of the processors 1612, 1632, 1642 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the measurement component 199 may be configured to transmit an indication to measure a set of positioning reference signal (PRS) resources, where each of the set of PRS resources is associated with a plurality of timing error groups (TEGs). The measurement component 199 may also be configured to receive a report of at least one measurement for each of the set of PRS resources from a user equipment (UE), the at least one measurement being performed within a measurement period, where the at least one measurement corresponds to at least one TEG in the plurality of TEGs for each of the set of PRS resources. The measurement component 199 may also be configured to receive a capability indication from the UE, where the capability indication indicates at least one of a processing capability of the UE to perform the at least one measurement for the set of PRS resources or a buffering capability of the UE to store data associated with the at least one measurement for the set of PRS resources, where the indication is transmitted based on the capability indication. The measurement component 199 may also be configured to transmit PRS assistance data based on the capability indication, where the set of PRS resources is based on the PRS assistance data.

The measurement component 199 may be within one or more processors of one or more of the CU 1610, DU 1630, and the RU 1640. The measurement component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 1602 may include a variety of components configured for various functions. In one configuration, the network entity 1602 may include means for transmitting an indication to measure a set of positioning reference signal (PRS) resources, where each of the set of PRS resources is associated with a plurality of timing error groups (TEGs). The network entity 1602 may also include means for receiving a report of at least one measurement for each of the set of PRS resources from a user equipment (UE), the at least one measurement being performed within a measurement period, where the at least one measurement corresponds to at least one TEG in the plurality of TEGs for each of the set of PRS resources. The network entity 1602 may also include means for receiving a capability indication from the UE, where the capability indication indicates at least one of a processing capability of the UE to perform the at least one measurement for the set of PRS resources or a buffering capability of the UE to store data associated with the at least one measurement for the set of PRS resources, where the indication is transmitted based on the capability indication. The network entity 1602 may also include means for transmitting PRS assistance data based on the capability indication, where the set of PRS resources is based on the PRS assistance data. The means may be the measurement component 199 of the network entity 1602 configured to perform the functions recited by the means. As described supra, the network entity 1602 may include the TX processor 316, the RX processor 370, and the controller/processor 375. As such, in one configuration, the means may be the TX processor 316, the RX processor 370, and/or the controller/processor 375 configured to perform the functions recited by the means.

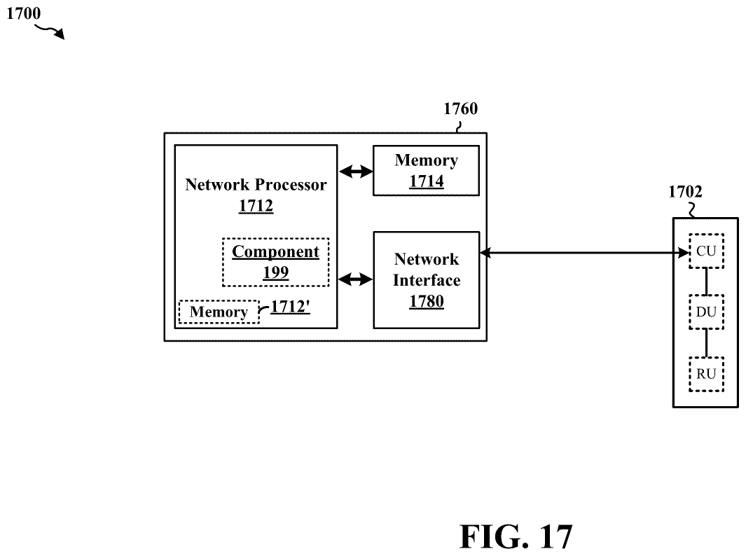

FIG. 17 is a diagram 1700 illustrating an example of a hardware implementation for a network entity 1760. In one example, the network entity 1760 may be within the core network 120. The network entity 1760 may include a network processor 1712. The network processor 1712 may include on-chip memory 1712′. In some aspects, the network entity 1760 may further include additional memory modules 1714. The network entity 1760 communicates via the network interface 1780 directly (e.g., backhaul link) or indirectly (e.g., through a RIC) with the CU 1702. The on-chip memory 1712′ and the additional memory modules 1714 may each be considered a computer-readable medium/memory. Each computer-readable medium/memory may be non-transitory. The processor 1712 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the measurement component 199 may be configured to transmit an indication to measure a set of positioning reference signal (PRS) resources, where each of the set of PRS resources is associated with a plurality of timing error groups (TEGs). The measurement component 199 may also be configured to receive a report of at least one measurement for each of the set of PRS resources from a user equipment (UE), the at least one measurement being performed within a measurement period, where the at least one measurement corresponds to at least one TEG in the plurality of TEGs for each of the set of PRS resources. The measurement component 199 may also be configured to receive a capability indication from the UE, where the capability indication indicates at least one of a processing capability of the UE to perform the at least one measurement for the set of PRS resources or a buffering capability of the UE to store data associated with the at least one measurement for the set of PRS resources, where the indication is transmitted based on the capability indication. The measurement component 199 may also be configured to transmit PRS assistance data based on the capability indication, where the set of PRS resources is based on the PRS assistance data.

The measurement component 199 may be within the processor 1712. The measurement component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 1760 may include a variety of components configured for various functions. In one configuration, the network entity 1760 may include means for transmitting an indication to measure a set of positioning reference signal (PRS) resources, where each of the set of PRS resources is associated with a plurality of timing error groups (TEGs). The network entity 1760 may also include means for receiving a report of at least one measurement for each of the set of PRS resources from a user equipment (UE), the at least one measurement being performed within a measurement period, where the at least one measurement corresponds to at least one TEG in the plurality of TEGs for each of the set of PRS resources. The network entity 1760 may also include means for receiving a capability indication from the UE, where the capability indication indicates at least one of a processing capability of the UE to perform the at least one measurement for the set of PRS resources or a buffering capability of the UE to store data associated with the at least one measurement for the set of PRS resources, where the indication is transmitted based on the capability indication. The network entity 1760 may also include means for transmitting PRS assistance data based on the capability indication, where the set of PRS resources is based on the PRS assistance data. The means may be the measurement component 199 of the network entity 1760 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is an apparatus for wireless communication at a user equipment (UE), including a memory and at least one processor coupled to the memory and, based at least in part on information stored in the memory, the at least one processor is configured to: obtain an indication to measure a set of positioning reference signal (PRS) resources, where each of the set of PRS resources is associated with a plurality of timing error groups (TEGs); perform, based on the indication, at least one measurement for each of the set of PRS resources, the at least one measurement being performed within a measurement period, where the at least one measurement corresponds to at least one TEG in the plurality of TEGs for each of the set of PRS resources; and transmit a report of the at least one measurement for each of the set of PRS resources to a network entity.

Aspect 2 is the apparatus of aspect 1, where a length of the measurement period corresponds to: T_{RSTD,i}=(CSSF_{PRS,i}*N_{RxBeam,i}*X*Nₛₐₘₚₗₑ−1)*T_{effect,i}+T_{last,i}, where T_{RSTD,i} is the length of the measurement period for a positioning frequency layer (PFL), i is a PFL index, CSSF_{PRS,i} is a carrier-specific scaling factor (CSSF) for PRS-based measurements, N_{RxBeam,i} is a UE reception (Rx) beam sweeping factor, Nₛₐₘₚₗₑ is a number of PRS reference signal time difference (RSTD) samples,

$${T}_{effect , i} = ⌈ \frac{{T}_{i}}{{T}_{available \_ PRS , i}} ⌉ * {T}_{available \_ PRS , i} ,$$

Tᵢ is a time for processing a duration of the PRS resources for the PFL index, T_{available_PRS,i} is a least common multiple between T_{PRS,i} and MGRPᵢ, T_{PRS,i} is an effective PRS periodicity with PRS muting, MGRPᵢ is a measurement gap periodicity, Tₗₐₛₜ is a measurement duration for a last PRS sample, and X is a first variable.

Aspect 3 is the apparatus of aspect 2, where

$$X = min ( M ⌈ \frac{{N}_{PRS , i}^{s l o t}}{{KN}_{i}^{′}} ⌉ ⌈ \frac{{L}_{available \_ PRS , i}}{K {N}_{i}} ⌉ , ⌈ \frac{M \cdot {N}_{PRS , i}^{s l o t}}{{KN}_{i}^{′}} ⌉ ⌈ \frac{M \cdot {L}_{available \_ PRS , i}}{K {N}_{i}} ⌉ ) ,$$

where N_{PRS,i}^{slot} is a maximum number of downlink (DL) PRS resources per slot in a time period for a PRS to be measured, M is a number of UE Rx TEGs, Nᵢ is one or more first UE capabilities for a duration of PRSs to be processed in Tᵢ, Nᵢ′ is one or more second UE capabilities for a maximum number of PRS resources per slot to be processed by the UE, L_{available_PRS,i} is a time duration of available PRSs to be measured during T_{available_PRS,i}, and K=1 or K is equal to a number of simultaneous measurements per PRS resource associated with different TEGs supported by the UE.

Aspect 4 is the apparatus of aspect 2, where

$$X = ⌈ \frac{M \cdot {N}_{PRS , i}^{s l o t}}{{KN}_{i}^{′}} ⌉ ⌈ \frac{M \cdot {L}_{available \_ PRS , i}}{K {N}_{i}} ⌉ ,$$

where N_{PRS,i}^{slot} is a maximum number of downlink (DL) PRS resources per slot in a time period for a PRS to be measured, M is a number of UE Rx TEGs, Nᵢ is one or more first UE capabilities for a duration of PRSs to be processed in Tᵢ, Nᵢ′ is one or more second UE capabilities for a maximum number of PRS resources per slot to be processed by the UE, L_{available_PRS,i} is a time duration of available PRSs to be measured during T_{available_PRS,i}, and K=1 or K is equal to a number of simultaneous measurements per PRS resource associated with different TEGs supported by the UE.

Aspect 5 is the apparatus of aspect 2, where

$$X = ⌈ \frac{{N}_{PRS , i}^{s l o t}}{{KN}_{i}^{′}} ⌉ ⌈ \frac{M \cdot {L}_{available \_ PRS , i}}{K {N}_{i}} ⌉ ,$$

where N_{PRS,i}^{slot} is a maximum number of downlink (DL) PRS resources per slot in a time period for a PRS to be measured, M is a number of UE Rx TEGs, Nᵢ is one or more first UE capabilities for a duration of PRSs to be processed in Tᵢ, Nᵢ′ is one or more second UE capabilities for a maximum number of PRS resources per slot to be processed by the UE, L_{available_PRS,i} is a time duration of available PRSs to be measured during T_{available_PRS,i}, and K=1 or K is equal to a number of simultaneous measurements per PRS resource associated with different TEGs supported by the UE.

Aspect 6 is the apparatus of aspect 2, where

$$X = ⌈ \frac{M \cdot {N}_{PRS , i}^{s l o t}}{{KN}_{i}^{′}} ⌉ ⌈ \frac{{L}_{available \_ PRS , i}}{K {N}_{i}} ⌉ ,$$

where N_{PRS,i}^{slot} is a maximum number of downlink (DL) PRS resources per slot in a time period for a PRS to be measured, M is a number of UE Rx TEGs, Nᵢ is one or more first UE capabilities for a duration of PRSs to be processed in Tᵢ, Nᵢ′ is one or more second UE capabilities for a maximum number of PRS resources per slot to be processed by the UE, L_{available_PRS,i} is a time duration of available PRSs to be measured during T_{available_PRS,i}, and K=1 or K is equal to a number of simultaneous measurements per PRS resource associated with different TEGs supported by the UE.

Aspect 7 is the apparatus of aspect 2, where

$$X = {min}_{r ∈ S} ( ⌈ \frac{M}{r} ⌉ ⌈ \frac{r \cdot {N}_{PRS , i}^{s l o t}}{{KN}_{i}^{′}} ⌉ ⌈ \frac{r \cdot {L}_{available \_ PRS , i}}{K {N}_{i}} ⌉ ) ,$$

where N_{PRS,i}^{slot} is a maximum number of downlink (DL) PRS resources per slot in a time period for a PRS to be measured, M is a number of UE Rx TEGs, Nᵢ is one or more first UE capabilities for a duration of PRSs to be processed in Tᵢ, Nᵢ′ is one or more second UE capabilities for a maximum number of PRS resources per slot to be processed by the UE, L_{available_PRS,i} is a time duration of available PRSs to be measured during T_{available_PRS,i}, K=1 or K is equal to a number of simultaneous measurements per PRS resource associated with different TEGs supported by the UE, S is a subset of {1, 2, . . . , M}, and r is a number of measurements per PRS resource that the UE chooses to perform simultaneously.

Aspect 8 is the apparatus of any of aspects 1 to 7, where the at least one processor is further configured to: transmit a capability indication to the network entity, where the capability indication indicates at least one of a processing capability of the UE to perform the at least one measurement for the set of PRS resources or a buffering capability of the UE to store data associated with the at least one measurement for the set of PRS resources, where the indication is obtained based on the capability indication.

Aspect 9 is the apparatus of aspect 8, where the at least one processor is further configured to: receive PRS assistance data based on the capability indication, where the set of PRS resources is based on the PRS assistance data.

Aspect 10 is the apparatus of any of aspects 1 to 9, where the at least one processor is further configured to: allocate an amount of a first memory or a first buffer for data associated with the at least one measurement for each of the set of PRS resources; and store the data associated with the at least one measurement for each of the set of PRS resources in the allocated amount of the first memory or the first buffer.

Aspect 11 is the apparatus of any of aspects 1 to 10, where each of the set of PRS resources is further associated with one transmission-reception point (TRP) in a set of TRPs.

Aspect 12 is the apparatus of any of aspects 1 to 11, where the plurality of TEGs includes at least one of: a reception (Rx) TEG or a reception-transmission (Rx-Tx) TEG.

Aspect 13 is the apparatus of any of aspects 1 to 12, where the at least one TEG is associated with a group of measurements, where a relative timing error for a pair of measurements in the group of measurements is within a margin of error.

Aspect 14 is the apparatus of any of aspects 1 to 13, where the set of PRS resources is associated with a same slot in a plurality of slots, such that the at least one measurement is performed for each PRS resource of the set of PRS resources in the same slot.

Aspect 15 is the apparatus of any of aspects 1 to 14, where to obtain the indication to measure the set of PRS resources, the at least one processor is configured to: receive a request to measure the set of PRS resources from the network entity, where the measurement period is associated with a time period during which the UE is expected to perform the at least one measurement.

Aspect 16 is an apparatus for wireless communication at a network entity, including a memory and at least one processor coupled to the memory and, based at least in part on information stored in the memory, the at least one processor is configured to: transmit an indication to measure a set of positioning reference signal (PRS) resources, where a plurality of measurements for each of the set of PRS resources is associated with a plurality of timing error groups (TEGs); and receive a report of at least one measurement for each of the set of PRS resources from a user equipment (UE), the at least one measurement being performed within a measurement period, where the at least one measurement corresponds to at least one TEG in the plurality of TEGs for each of the set of PRS resources.

Aspect 17 is the apparatus of any of aspect 16, where a length of the measurement period corresponds to: T_{RSTD,i}=(CSSF_{PRS,i}*N_{RxBeam,i}*X*Nₛₐₘₚₗₑ−1)*T_{effect,i}+T_{last,i}, where T_{RSTD,i} is the length of the measurement period for a positioning frequency layer (PFL), i is a PFL index, CSSF_{PRS,i} is a carrier-specific scaling factor (CSSF) for PRS-based measurements, N_{RxBeam,i} is a UE reception (Rx) beam sweeping factor, Nₛₐₘₚₗₑ is a number of PRS reference signal time difference (RSTD) samples,

$${T}_{effect , i} = ⌈ \frac{{T}_{i}}{{T}_{available \_ PRS , i}} ⌉ * {T}_{available \_ PRS , i} ,$$

Tᵢ is a time for processing a duration of the PRS resources for the PFL index, T_{available_PRS,i} is a least common multiple between T_{PRS,i} and MGRPᵢ, T_{PRS,i} is an effective PRS periodicity with PRS muting, MGRPᵢ is a measurement gap periodicity, Tₗₐₛₜ is a measurement duration for a last PRS sample, and X is a first variable.

Aspect 18 is the apparatus of aspect 17, where

$$X = min ( M ⌈ \frac{{N}_{PRS , i}^{s l o t}}{{KN}_{i}^{′}} ⌉ ⌈ \frac{{L}_{available \_ PRS , i}}{K {N}_{i}} ⌉ , ⌈ \frac{M \cdot {N}_{PRS , i}^{s l o t}}{{KN}_{i}^{′}} ⌉ ⌈ \frac{M \cdot {L}_{available \_ PRS , i}}{K {N}_{i}} ⌉ ) ,$$

where N_{PRS,i}^{slot} is a maximum number of downlink (DL) PRS resources per slot in a time period for a PRS to be measured, M is a number of UE Rx TEGs, Nᵢ is one or more first UE capabilities for a duration of PRSs to be processed in Tᵢ, Nᵢ′ is one or more second UE capabilities for a maximum number of PRS resources per slot to be processed by the UE, L_{available_PRS,i} is a time duration of available PRSs to be measured during T_{available_PRS,i}, and K=1 or K is equal to a number of simultaneous measurements per PRS resource associated with different TEGs supported by the UE.

Aspect 19 is the apparatus of aspect 17, where

$$X = ⌈ \frac{M \cdot {N}_{PRS , i}^{s l o t}}{{KN}_{i}^{′}} ⌉ ⌈ \frac{M \cdot {L}_{available \_ PRS , i}}{K {N}_{i}} ⌉ ,$$

where N_{PRS,i}^{slot} is a maximum number of downlink (DL) PRS resources per slot in a time period for a PRS to be measured, M is a number of UE Rx TEGs, Nᵢ is one or more first UE capabilities for a duration of PRSs to be processed in Tᵢ, Nᵢ′ is one or more second UE capabilities for a maximum number of PRS resources per slot to be processed by the UE, L_{available_PRS,i} is a time duration of available PRSs to be measured during T_{available_PRS,i}, and K=1 or K is equal to a number of simultaneous measurements per PRS resource associated with different TEGs supported by the UE.

Aspect 20 is the apparatus of aspect 17, where

$$X = ⌈ \frac{{N}_{PRS , i}^{slot}}{{KN}_{i}^{′}} ⌉ ⌈ \frac{M \cdot {L}_{available \_ PRS , i}}{{KN}_{i}} ⌉ ,$$

where N_{PRS,i}^{slot} is a maximum number of downlink (DL) PRS resources per slot in a time period for a PRS to be measured, M is a number of UE Rx TEGs, Nᵢ is one or more first UE capabilities for a duration of PRSs to be processed in Tᵢ, Nᵢ′ is one or more second UE capabilities for a maximum number of PRS resources per slot to be processed by the UE, L_{available_PRS,i} is a time duration of available PRSs to be measured during T_{available_PRS,i}, and K=1 or K is equal to a number of simultaneous measurements per PRS resource associated with different TEGs supported by the UE.

Aspect 21 is the apparatus of aspect 17, where

$$X = ⌈ \frac{M \cdot {N}_{PRS , i}^{slot}}{{KN}_{i}^{′}} ⌉ ⌈ \frac{{L}_{available \_ PRS , i}}{{KN}_{i}} ⌉ ,$$

where N_{PRS,i}^{slot} is a maximum number of downlink (DL) PRS resources per slot in a time period for a PRS to be measured, M is a number of UE Rx TEGs, Nᵢ is one or more first UE capabilities for a duration of PRSs to be processed in Tᵢ, Nᵢ′ is one or more second UE capabilities for a maximum number of PRS resources per slot to be processed by the UE, L_{available_PRS,i} is a time duration of available PRSs to be measured during T_{available_PRS,i}, and K=1 or K is equal to a number of simultaneous measurements per PRS resource associated with different TEGs supported by the UE.

Aspect 22 is the apparatus of aspect 17, where

$$X = {min}_{r ∈ S} ( ⌈ \frac{M}{r} ⌉ ⌈ \frac{r \cdot {N}_{PRS , i}^{slot}}{{KN}_{i}^{′}} ⌉ ⌈ \frac{r \cdot {L}_{available \_ PRS , i}}{{KN}_{i}} ⌉ ) ,$$

where N_{PRS,i}^{slot} is a maximum number of downlink (DL) PRS resources per slot in a time period for a PRS to be measured, M is a number of UE Rx TEGs, Nᵢ is one or more first UE capabilities for a duration of PRSs to be processed in Tᵢ, Nᵢ′ is one or more second UE capabilities for a maximum number of PRS resources per slot to be processed by the UE, L_{available_PRS,i} is a time duration of available PRSs to be measured during T_{available_PRS,i}, K=1 or K is equal to a number of simultaneous measurements per PRS resource associated with different TEGs supported by the UE, S is a subset of {1, 2, . . . , M}, and r is a number of measurements per PRS resource that the UE chooses to perform simultaneously.

Aspect 23 is the apparatus of any of aspects 16 to 22, where the at least one processor is further configured to: receive a capability indication from the UE, where the capability indication indicates at least one of a processing capability of the UE to perform the at least one measurement for the set of PRS resources or a buffering capability of the UE to store data associated with the at least one measurement for the set of PRS resources, where the indication is transmitted based on the capability indication.

Aspect 24 is the apparatus of aspect 23, where the at least one processor is further configured to: transmit PRS assistance data based on the capability indication, where the set of PRS resources is based on the PRS assistance data.

Aspect 25 is the apparatus of any of aspects 16 to 24, where each of the set of PRS resources is further associated with one transmission-reception point (TRP) in a set of TRPs.

Aspect 26 is the apparatus of any of aspects 16 to 25, where the plurality of TEGs includes at least one of: a reception (Rx) TEG or a reception-transmission (Rx-Tx) TEG.

Aspect 27 is the apparatus of any of aspects 16 to 26, where the at least one TEG is associated with a group of measurements, where a relative timing error for a pair of measurements in the group of measurements is within a margin of error.

Aspect 28 is the apparatus of any of aspects 16 to 27, where the set of PRS resources is associated with a same slot in a plurality of slots, such that the at least one measurement is performed for each PRS resource of the set of PRS resources in the same slot, where the measurement period is associated with a time period during which the UE is expected to perform the at least one measurement.

Aspect 29 is the apparatus of any of aspects 1 to 28, where the apparatus is a wireless communication device, further including at least one of an antenna or a transceiver coupled to the at least one processor.

Aspect 30 is a wireless communication for implementing any of aspects 1 to 29.

Aspect 31 is an apparatus for wireless communication including means for implementing any of aspects 1 to 29.

Aspect 32 is a computer-readable medium (e.g., a non-transitory computer-readable medium) storing computer executable code, the code when executed by at least one processor causes the at least one processor to implement any of aspects 1 to 29.

What is claimed is:

1. An apparatus for wireless communication at a user equipment (UE), comprising:
a memory; and
at least one processor coupled to the memory and, based at least in part on information stored in the memory, the at least one processor is configured to:
obtain an indication to measure a set of positioning reference signal (PRS) resources, wherein each of the set of PRS resources is associated with a plurality of timing error groups (TEGs);
perform, based on the indication, at least one measurement for each of the set of PRS resources, the at least one measurement being performed within a measurement period, wherein the at least one measurement corresponds to at least one TEG in the plurality of TEGs for each of the set of PRS resources; and
transmit a report of the at least one measurement for each of the set of PRS resources to a network entity.

2. The apparatus of claim 1, wherein a length of the measurement period corresponds to: T_{RSTD,i}=(CSSF_{PRS,i}*N_{RxBeam,i}*X*Nₛₐₘₚₗₑ−1)*T_{effect,i}+T_{last,i}, where T_{RSTD,i} is the length of the measurement period for a positioning frequency layer (PFL), i is a PFL index, CSSF_{PRS,i} is a carrier-specific scaling factor (CSSF) for PRS-based measurements, N_{RxBeam,i} is a UE reception (Rx) beam sweeping factor, Nₛₐₘₚₗₑ is a number of PRS reference signal time difference (RSTD) samples,
$${T}_{effect , i} = ⌈ \frac{{T}_{i}}{{T}_{available \_ PRS , i}} ⌉ * {T}_{available \_ PRS , i} ,$$
Tᵢ is a time for processing a duration of the PRS resources for the PFL index, T_{available_PRS,i} is a least common multiple between T_{PRS,i} and MGRPᵢ, T_{PRS,i} is an effective PRS periodicity with PRS muting, MGRPᵢ is a measurement gap periodicity, Tₗₐₛₜ is a measurement duration for a last PRS sample, and X is a first variable.

3. The apparatus of claim 2, wherein
$$X = min ( M ⌈ \frac{{N}_{PRS , i}^{slot}}{{KN}_{i}^{′}} ⌉ ⌈ \frac{{L}_{available \_ PRS , i}}{{KN}_{i}} ⌉ , ⌈ \frac{M \cdot {N}_{PRS , i}^{slot}}{{KN}_{i}^{′}} ⌉ ⌈ \frac{M \cdot {L}_{available \_ PRS , i}}{{KN}_{i}} ⌉ ) ,$$
where N_{PRS,i}^{slot} is a maximum number of downlink (DL) PRS resources per slot in a time period for a PRS to be measured, M is a number of UE Rx TEGs, Nᵢ is one or more first UE capabilities for a duration of PRSs to be processed in Tᵢ, Nᵢ′ is one or more second UE capabilities for a maximum number of PRS resources per slot to be processed by the UE, L_{available_PRS,i} is a time duration of available PRSs to be measured during T_{available_PRS,i}, and K=1 or K is equal to a number of simultaneous measurements per PRS resource associated with different TEGs supported by the UE.

4. The apparatus of claim 2, wherein
$$X = ⌈ \frac{M \cdot {N}_{PRS , i}^{slot}}{{KN}_{i}^{′}} ⌉ ⌈ \frac{M \cdot {L}_{available \_ PRS , i}}{{KN}_{i}} ⌉ ,$$
where N_{PRS,i}^{slot} is a maximum number of downlink (DL) PRS resources per slot in a time period for a PRS to be measured, M is a number of UE Rx TEGs, Nᵢ is one or more first UE capabilities for a duration of PRSs to be processed in Tᵢ, Nᵢ′ is one or more second UE capabilities for a maximum number of PRS resources per slot to be processed by the UE, L_{available_PRS,i} is a time duration of available PRSs to be measured during T_{available_PRS,i}, and K=1 or K is equal to a number of simultaneous measurements per PRS resource associated with different TEGs supported by the UE.

5. The apparatus of claim 2, wherein
$$X = ⌈ \frac{{N}_{PRS , i}^{slot}}{{KN}_{i}^{′}} ⌉ ⌈ \frac{M \cdot {L}_{available \_ PRS , i}}{{KN}_{i}} ⌉ ,$$
where N_{PRS,i}^{slot} is a maximum number of downlink (DL) PRS resources per slot in a time period for a PRS to be measured, M is a number of UE Rx TEGs, Nᵢ is one or more first UE capabilities for a duration of PRSs to be processed in Tᵢ, Nᵢ′ is one or more second UE capabilities for a maximum number of PRS resources per slot to be processed by the UE, L_{available_PRS,i} is a time duration of available PRSs to be measured during T_{available_PRS,i}, and K=1 or K is equal to a number of simultaneous measurements per PRS resource associated with different TEGs supported by the UE.

6. The apparatus of claim 2, wherein
$$X = ⌈ \frac{M \cdot {N}_{PRS , i}^{slot}}{{KN}_{i}^{′}} ⌉ ⌈ \frac{{L}_{available \_ PRS , i}}{{KN}_{i}} ⌉ ,$$
where N_{PRS,i}^{slot} is a maximum number of downlink (DL) PRS resources per slot in a time period for a PRS to be measured, M is a number of UE Rx TEGs, Nᵢ is one or more first UE capabilities for a duration of PRSs to be processed in Tᵢ, Nᵢ′ is one or more second UE capabilities for a maximum number of PRS resources per slot to be processed by the UE, L_{available_PRS,i} is a time duration of available PRSs to be measured during T_{available_PRS,i}, and K=1 or K is equal to a number of simultaneous measurements per PRS resource associated with different TEGs supported by the UE.

7. The apparatus of claim 2, wherein
$$X = {min}_{r ∈ S} ( ⌈ \frac{M}{r} ⌉ ⌈ \frac{r \cdot {N}_{PRS , i}^{slot}}{{KN}_{i}^{′}} ⌉ ⌈ \frac{r \cdot {L}_{available \_ PRS , i}}{{KN}_{i}} ⌉ ) ,$$
where N_{PRS,i}^{slot} is a maximum number of downlink (DL) PRS resources per slot in a time period for a PRS to be measured, M is a number of UE Rx TEGs, Nᵢ is one or more first UE capabilities for a duration of PRSs to be processed in Tᵢ, Nᵢ′ is one or more second UE capabilities for a maximum number of PRS resources per slot to be processed by the UE, L_{available_PRS,i} is a time duration of available PRSs to be measured during T_{available_PRS,i}, K=1 or K is equal to a number of simultaneous measurements per PRS resource associated with different TEGs supported by the UE, S is a subset of {1, 2, . . . , M}, and r is a number of measurements per PRS resource that the UE chooses to perform simultaneously.

8. The apparatus of claim 1, wherein the at least one processor is further configured to:
transmit a capability indication to the network entity, wherein the capability indication indicates at least one of a processing capability of the UE to perform the at least one measurement for the set of PRS resources or a buffering capability of the UE to store data associated with the at least one measurement for the set of PRS resources, and wherein to obtain the indication, the at least one processor is configured to obtain the indication based on the capability indication.

9. The apparatus of claim 8, wherein the at least one processor is further configured to:
receive PRS assistance data based on the capability indication, wherein the set of PRS resources is based on the PRS assistance data.

10. The apparatus of claim 1, wherein the at least one processor is further configured to:
allocate an amount of a first memory or a first buffer for data associated with the at least one measurement for each of the set of PRS resources; and
store the data associated with the at least one measurement for each of the set of PRS resources in the allocated amount of the first memory or the first buffer.

11. The apparatus of claim 1, wherein each of the set of PRS resources is further associated with one transmission-reception point (TRP) in a set of TRPs.

12. The apparatus of claim 1, wherein the plurality of TEGs includes at least one of: a reception (Rx) TEG or a reception-transmission (Rx-Tx) TEG.

13. The apparatus of claim 1, wherein the at least one TEG is associated with a group of measurements, where a relative timing error for a pair of measurements in the group of measurements is within a margin of error.

14. The apparatus of claim 1, wherein the set of PRS resources is associated with a same slot in a plurality of slots, such that the at least one measurement is performed for each PRS resource of the set of PRS resources in the same slot.

15. The apparatus of claim 1, wherein to obtain the indication to measure the set of PRS resources, the at least one processor is configured to: receive a request to measure the set of PRS resources from the network entity, wherein the measurement period is associated with a time period during which the UE is expected to perform the at least one measurement.

16. An apparatus for wireless communication at a network entity, comprising:
a memory; and
at least one processor coupled to the memory and, based at least in part on information stored in the memory, the at least one processor is configured to:
transmit an indication to measure a set of positioning reference signal (PRS) resources, wherein a plurality of measurements for each of the set of PRS resources is associated with a plurality of timing error groups (TEGs); and
receive a report of at least one measurement for each of the set of PRS resources from a user equipment (UE), the at least one measurement being performed within a measurement period, wherein the at least one measurement corresponds to at least one TEG in the plurality of TEGs for each of the set of PRS resources.

17. The apparatus of claim 16, wherein a length of the measurement period corresponds to: T_{RSTD,i}=(CSSF_{PRS,i}*N_{RxBeam,i}*X*Nₛₐₘₚₗₑ−1)*T_{effect,i}+T_{last,i}, where T_{RSTD,i} is the length of the measurement period for a positioning frequency layer (PFL), i is a PFL index, CSSF_{PRS,i} is a carrier-specific scaling factor (CSSF) for PRS-based measurements, N_{RxBeam,i} is a UE reception (Rx) beam sweeping factor, Nₛₐₘₚₗₑ is a number of PRS reference signal time difference (RSTD) samples,
$${T}_{effect , i} = ⌈ \frac{{T}_{i}}{{T}_{available \_ PRS , i}} ⌉ * {T}_{available \_ PRS , i} ,$$
Tᵢ is a time for processing a duration of the PRS resources for the PFL index, T_{available_PRS,i} is a least common multiple between T_{PRS,i} and MGRPᵢ, T_{PRS,i} is an effective PRS periodicity with PRS muting, MGRPᵢ is a measurement gap periodicity, Tₗₐₛₜ is a measurement duration for a last PRS sample, and X is a first variable.

18. The apparatus of claim 17, wherein
$$X = min ( M ⌈ \frac{{N}_{PRS , i}^{slot}}{{KN}_{i}^{′}} ⌉ ⌈ \frac{{L}_{available \_ PRS , i}}{{KN}_{i}} ⌉ , ⌈ \frac{M \cdot {N}_{PRS , i}^{slot}}{{KN}_{i}^{′}} ⌉ ⌈ \frac{M \cdot {L}_{available \_ PRS , i}}{{KN}_{i}} ⌉ ) ,$$
where N_{PRS,i}^{slot} is a maximum number of downlink (DL) PRS resources per slot in a time period for a PRS to be measured, M is a number of UE Rx TEGs, Nᵢ is one or more first UE capabilities for a duration of PRSs to be processed in Tᵢ, Nᵢ′ is one or more second UE capabilities for a maximum number of PRS resources per slot to be processed by the UE, L_{available_PRS,i}s a time duration of available PRSs to be measured during T_{available_PRS,i}, and K=1 or K is equal to a number of simultaneous measurements per PRS resource associated with different TEGs supported by the UE.

19. The apparatus of claim 17, wherein
$$X = ⌈ \frac{M \cdot {N}_{PRS , i}^{slot}}{{KN}_{i}^{′}} ⌉ ⌈ \frac{M \cdot {L}_{available \_ PRS , i}}{{KN}_{i}} ⌉ ,$$
where N_{PRS,i}^{slot} is a maximum number of downlink (DL) PRS resources per slot in a time period for a PRS to be measured, M is a number of UE Rx TEGs, Nᵢ is one or more first UE capabilities for a duration of PRSs to be processed in Tᵢ, Nᵢ′ is one or more second UE capabilities for a maximum number of PRS resources per slot to be processed by the UE, L_{available_PRS,i} is a time duration of available PRSs to be measured during T_{available_PRS,i}, and K=1 or K is equal to a number of simultaneous measurements per PRS resource associated with different TEGs supported by the UE.

20. The apparatus of claim 17, wherein
$$X = ⌈ \frac{{N}_{PRS , i}^{slot}}{{KN}_{i}^{′}} ⌉ ⌈ \frac{M \cdot {L}_{available \_ PRS , i}}{{KN}_{i}} ⌉ ,$$
where N_{PRS,i}^{slot} is a maximum number of downlink (DL) PRS resources per slot in a time period for a PRS to be measured, M is a number of UE Rx TEGs, Nᵢ is one or more first UE capabilities for a duration of PRSs to be processed in Tᵢ, Nᵢ′ is one or more second UE capabilities for a maximum number of PRS resources per slot to be processed by the UE, L_{available_PRS,i} is a time duration of available PRSs to be measured during T_{available_PRS,i}, and K=1 or K is equal to a number of simultaneous measurements per PRS resource associated with different TEGs supported by the UE.

21. The apparatus of claim 17, wherein
$$X = ⌈ \frac{M \cdot {N}_{PRS , i}^{slot}}{{KN}_{i}^{′}} ⌉ ⌈ \frac{{L}_{available \_ PRS , i}}{{KN}_{i}} ⌉ ,$$
where N_{PRS,i}^{slot} is a maximum number of downlink (DL) PRS resources per slot in a time period for a PRS to be measured, M is a number of UE Rx TEGs, Nᵢ is one or more first UE capabilities for a duration of PRSs to be processed in Tᵢ, Nᵢ′ is one or more second UE capabilities for a maximum number of PRS resources per slot to be processed by the UE, L_{available_PRS,i} is a time duration of available PRSs to be measured during T_{available_PRS,i}, and K=1 or K is equal to a number of simultaneous measurements per PRS resource associated with different TEGs supported by the UE.

22. The apparatus of claim 17, wherein
$$X = {min}_{r ∈ S} ( ⌈ \frac{M}{r} ⌉ ⌈ \frac{r \cdot {N}_{PRS , i}^{slot}}{{KN}_{i}^{′}} ⌉ ⌈ \frac{r \cdot {L}_{available \_ PRS , i}}{{KN}_{i}} ⌉ ) ,$$
where N_{PRS,i}^{slot} is a maximum number of downlink (DL) PRS resources per slot in a time period for a PRS to be measured, M is a number of UE Rx TEGs, Nᵢ is one or more first UE capabilities for a duration of PRSs to be processed in Tᵢ, Nᵢ′ is one or more second UE capabilities for a maximum number of PRS resources per slot to be processed by the UE, L_{available_PRS,i} is a time duration of available PRSs to be measured during T_{available_PRS,i}, K=1 or K is equal to a number of simultaneous measurements per PRS resource associated with different TEGs supported by the UE, S is a subset of {1, 2, . . . , M}, and r is a number of measurements per PRS resource that the UE chooses to perform simultaneously.

23. The apparatus of claim 16, wherein the at least one processor is further configured to:
receive a capability indication from the UE, wherein the capability indication indicates at least one of a processing capability of the UE to perform the at least one measurement for the set of PRS resources or a buffering capability of the UE to store data associated with the at least one measurement for the set of PRS resources, and wherein to transmit the indication, the at least one processor is configured to transmit the indication based on the capability indication.

24. The apparatus of claim 23, wherein the at least one processor is further configured to:
transmit PRS assistance data based on the capability indication, wherein the set of PRS resources is based on the PRS assistance data.

25. The apparatus of claim 16, wherein each of the set of PRS resources is further associated with one transmission-reception point (TRP) in a set of TRPs.

26. The apparatus of claim 16, wherein the plurality of TEGs includes at least one of: a reception (Rx) TEG or a reception-transmission (Rx-Tx) TEG.

27. The apparatus of claim 16, wherein the at least one TEG is associated with a group of measurements, where a relative timing error for a pair of measurements in the group of measurements is within a margin of error.

28. The apparatus of claim 16, wherein the set of PRS resources is associated with a same slot in a plurality of slots, such that the at least one measurement is performed for each PRS resource of the set of PRS resources in the same slot, wherein the measurement period is associated with a time period during which the UE is expected to perform the at least one measurement.

29. A method of wireless communication at a user equipment (UE), comprising:
obtaining an indication to measure a set of positioning reference signal (PRS) resources, wherein each of the set of PRS resources is associated with a plurality of timing error groups (TEGs);
performing, based on the indication, at least one measurement for each of the set of PRS resources, the at least one measurement being performed within a measurement period, wherein the at least one measurement corresponds to at least one TEG in the plurality of TEGs for each of the set of PRS resources; and
transmitting a report of the at least one measurement for each of the set of PRS resources to a network entity.

30. A method of wireless communication at a network entity, comprising:
transmitting an indication to measure a set of positioning reference signal (PRS) resources, wherein a plurality of measurements for each of the set of PRS resources is associated with a plurality of timing error groups (TEGs); and
receiving a report of at least one measurement for each of the set of PRS resources from a user equipment (UE), the at least one measurement being performed within a measurement period, wherein the at least one measurement corresponds to at least one TEG in the plurality of TEGs for each of the set of PRS resources.
